(19) United States
(12) Patent Application Publication
(10) Pub. No.: US 2024/0359356 A1
(43) Pub. Date: Oct. 31, 2024

(54) CIRCULAR SAW

(71) Applicant: Black & Decker Inc, New Britain, CT (US)

(72) Inventors: Austin L. Ganzermiller, Reisterstown, MD (US); Daniel L. Schwarz, Jarrettsville, MD (US)

(21) Appl. No.: 18/647,689

(22) Filed: Apr. 26, 2024

Related U.S. Application Data
(60) Provisional application No. 63/498,443, filed on Apr. 26, 2023.

(51) Int. Cl. B27B 9/02; B23D 45/16; B27G 19/04

(52) U.S. Cl. CPC B27B 9/02; B23D 45/16; B27G 19/04

(57) ABSTRACT

A device may include a first motor including a first motor output shaft coupled to a first pinion. A device may include a second motor including a second motor output shaft coupled to a second pinion. A device may include a transmission including: a master gear configured to engage the first pinion and the second pinion, an input pulley coupled to the master gear, the input pulley having a first diameter, and an output pulley coupled to an output shaft configured to rotate a saw blade, the output pulley having a second diameter that is smaller than the first diameter.

### CROSS-REFERENCE TO RELATED APPLICATIONS

This application claims priority to and the benefit of U.S. Provisional Application No. 63/498,443, filed on Apr. 26, 2023, and titled “Multi-Motor Drive System,” which is hereby incorporated by reference in its entirety.

### TECHNICAL FIELD

This description relates to features of a circular saw.

### BACKGROUND

Circular saws are used to cut many types of workpieces on a work site, including wood, metal, composite, plastic, etc.

Circular saws include a motor within a housing that turns a motor spindle coupled to a blade positioned inside an upper saw blade housing. Typically saws have a large single motor housed to the left or right side of an upper saw blade housing when in an operational position. The motor-beside-saw blade configuration can be bulky and asymmetrical and generally makes the circular saw awkward to use for some purposes. As a result, operators often need “a left-handed” or “a right-handed” circular saw based on operator handedness or desired application. The side placement of the motor may also move the center of mass (sometimes also referred to as center of gravity) of the circular saw away from a plane of the rotating saw blade. To support a side-mounted heavy motor during a cut, the circular saw's shoe tends to be asymmetrical with a much larger surface area on the motor side of the saw blade. However, a larger surface of the shoe on the motor side of a saw blade tends to constrains the use of the saw.

It is desirable to make a circular saw more ergonomical and adaptable to use to make a greater variety of cuts. It is also desirable to increase the power, decrease the weight, and increase the cut depth of the saw.

### SUMMARY

In some aspects, the techniques described herein relate to a circular saw including: a first motor including a first motor output shaft coupled to a first pinion; a second motor including a second motor output shaft coupled to a second pinion; and a transmission including: a master gear configured to engage the first pinion and the second pinion, an input pulley coupled to the master gear, the input pulley having a first diameter, and an output pulley coupled to an output shaft configured to rotate a saw blade, the output pulley having a second diameter that is smaller than the first diameter.

In some aspects, the techniques described herein relate to a circular saw, including: a housing; an upper blade housing coupled to the housing and rotatably coupled to an output shaft; the output shaft operable to rotate a saw blade coupled to the output shaft via a flange in a saw blade plane, the flange having a flange diameter; a motor at least partially enclosed within the housing and overlapping the saw blade plane; and an output rotatable drive element coupled to the output shaft and operable to be rotated by the motor, the output rotatable drive element having an output drive element diameter that is less than or equal to the flange diameter.

In some aspects, the techniques described herein relate to a circular saw, including: a saw blade in a saw blade plane; a first handle assembly; a motor housing and a motor positioned inside the motor housing, the motor housing between the saw blade and the first handle assembly; and a circular saw center of mass in the saw blade plane and between the first handle assembly and the motor housing.

### BRIEF DESCRIPTION OF THE DRAWINGS

FIG. 1 depicts a front elevation view of an example circular saw, in accordance with the present disclosure.

FIG. 2 depicts a right side elevation view of the circular saw of FIG. 1.

FIG. 3 depicts a rear elevation view of the circular saw of FIG. 1.

FIG. 4 depicts a left side elevation view of the circular saw of FIG. 1.

FIG. 5 depicts a top plan view of the circular saw of FIG. 1.

FIG. 6 depicts a bottom plan view of the circular saw of FIG. 1.

FIG. 7 depicts a top, front, right isometric view of the circular saw of FIG. 1.

FIG. 8 depicts a top, rear, right isometric view of the circular saw of FIG. 1.

FIG. 9 depicts a top, rear, left isometric view of the circular saw of FIG. 1.

FIG. 10 depicts a bottom, front, left isometric view of the circular saw of FIG. 1.

FIG. 11 depicts a top, front, right exploded view of the circular saw of FIG. 1.

FIG. 12 depicts a top, rear, left exploded view of the circular saw of FIG. 1.

FIG. 13 depicts a the detail area A of FIG. 2, with a right cover removed.

FIG. 14 depicts a right, rear exploded view of the circular saw of FIG. 1, with a right cover removed.

FIG. 15 depicts top, rear, left isometric view of an example set of motors of the circular saw of FIG. 1

FIG. 16 depicts a view of the set of motors and an example gear of the circular saw of FIG. 1.

FIG. 17 depicts an isometric view of various internal components of the circular saw of FIG. 1.

FIG. 18 depicts a plan view of various components of the circular saw of FIG. 1.

FIG. 19 depicts a cross-sectional view A-A centered on the master pulley of the circular as represented in FIG. 18.

FIG. 20 depicts the transmission and pulley drive of the circular saw of FIG. 1 with covers removed.

FIG. 21 depicts a front elevation view of the circular saw of FIG. 1 in a first bevel position.

FIG. 22 depicts a front elevation view of the circular saw of FIG. 1 in a second bevel position.

FIG. 23 depicts a cross-sectional isometric view B-B as represented in FIG. 4.

FIG. 24 depicts a front, right isometric view of the circular saw of FIG. 1.

FIG. 25 depicts a front, right, top isometric view of the circular saw of FIG. 1.

FIG. 26 depicts a right, top isometric view of the circular saw of FIG. 1.

FIG. 27 depicts an exploded isometric view of a secondary handle assembly of the circular saw of FIG. 1.

FIG. 28 depicts a cross-sectional view C-C as represented in FIG. 5.

FIG. 29 depicts a top, rear, left isometric view of the circular saw of FIG. 1.

FIG. 30 depicts a top, front, right isometric view of the circular saw of FIG. 1.

FIG. 31 depicts a top, front, right isometric view of the circular saw of FIG. 1 in a shipping configuration.

FIG. 32 depicts a top, front, right isometric view of the circular saw of FIG. 1 in a shipping configuration and illustrating a box volume.

FIG. 33A depicts a right side elevation view of the circular saw of FIG. 1 in a shipping configuration and FIG. 33B depicts a right internal view an example shipping container.

FIG. 34A depicts a top plan view of the circular saw of FIG. 1 in a shipping configuration and FIG. 34B depicts a top internal view of an example shipping container.

FIG. 35A depicts a rear elevation view of the circular saw of FIG. 1 in a shipping configuration and FIG. 35B depicts a rear internal view of an example shipping container.

### DETAILED DESCRIPTION

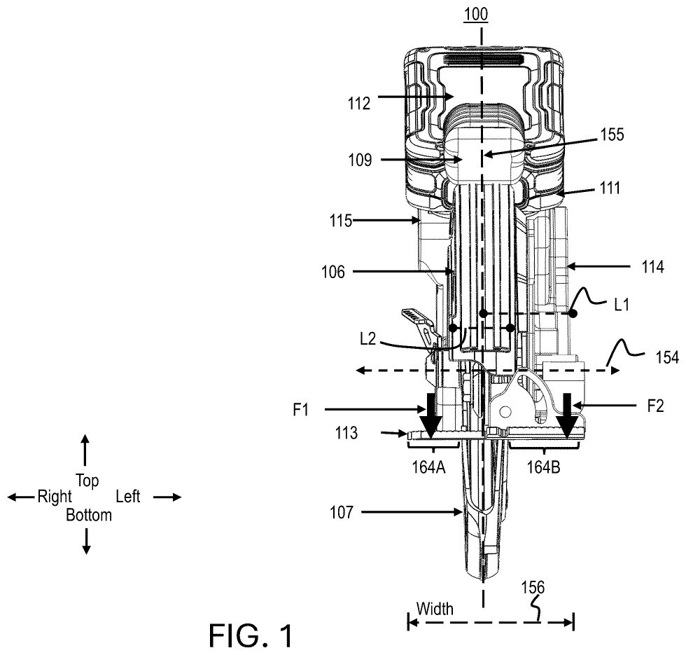

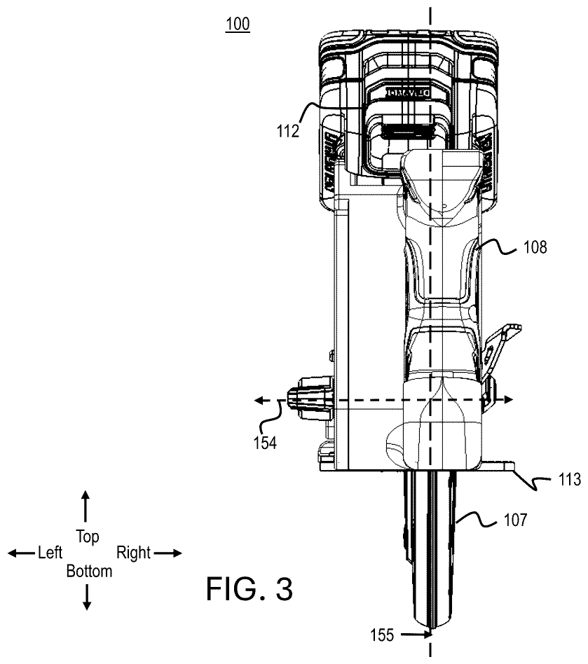

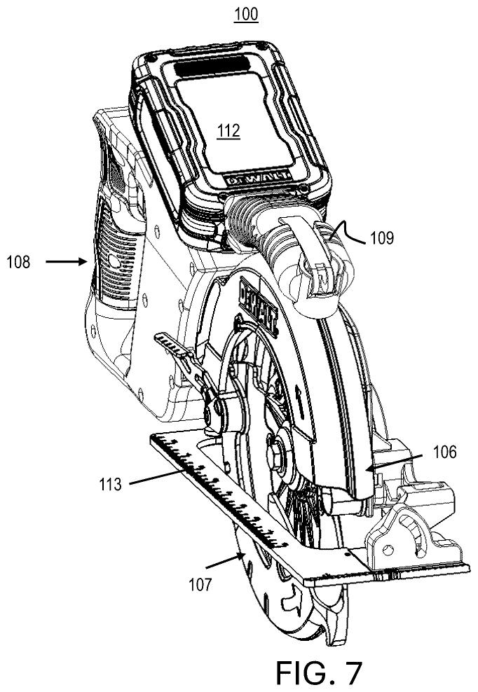

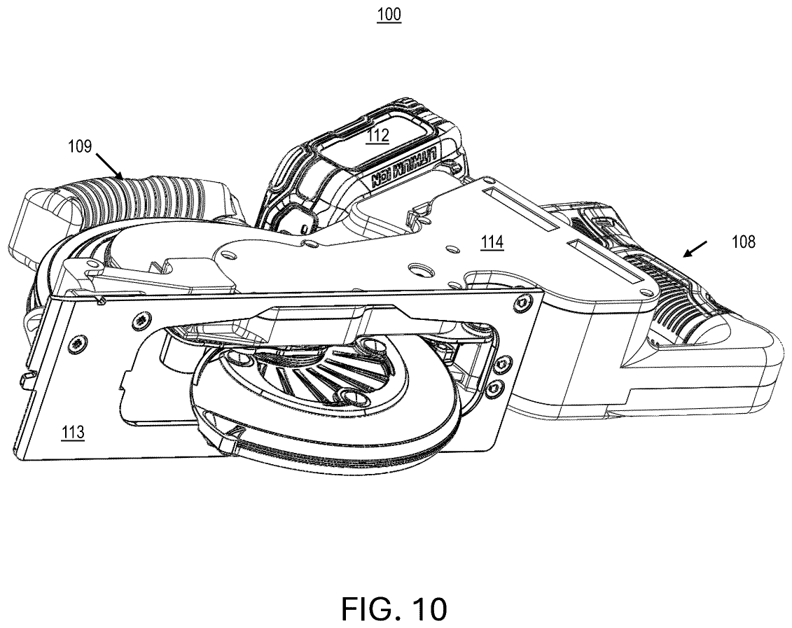

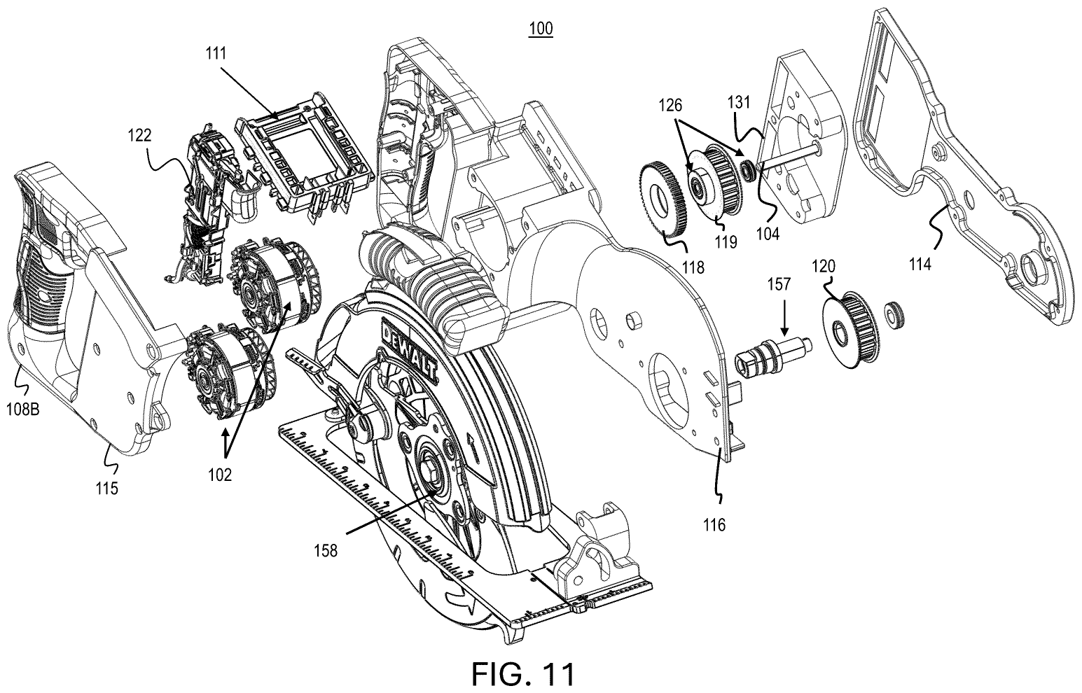

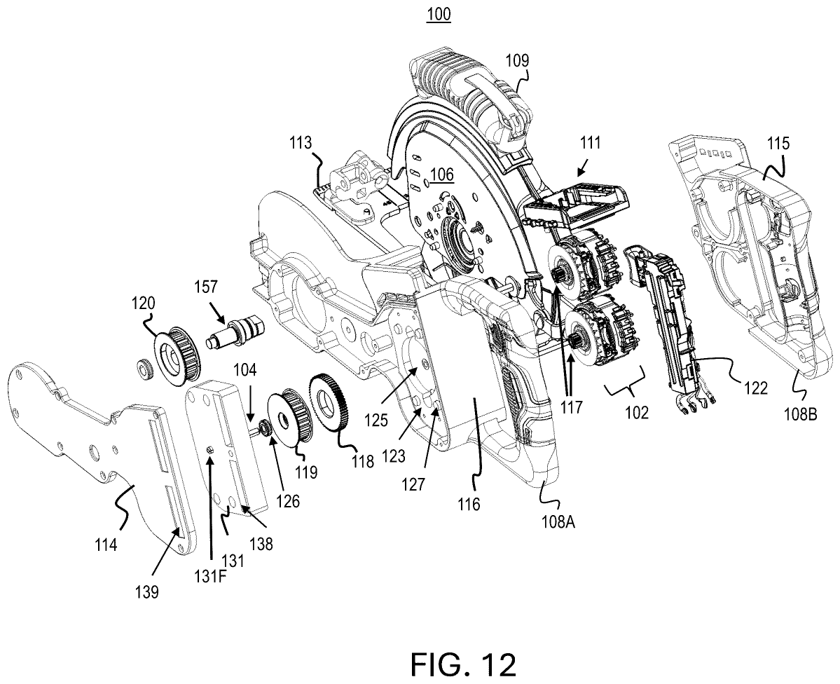

FIGS. 1-10 depict elevation and isometric views and FIGS. 11 and 12 depict exploded views of a circular saw 100, according to an example. The circular saw 100 may be used to cut any type of workpiece, including wood, metal, composite, plastic, etc. The circular saw 100 may include a blade housing assembly 105, a motor/transmission housing 153, a handle assembly 108, a stabilizing handle 109, a shoe 113, a battery receptacle 111 and a battery pack 112, and a rotating saw blade (not pictured).

In this description, the terms ‘left’, ‘right’, ‘top’, ‘bottom’, ‘rear’, and ‘front’ are used to describe relative positions of the circular saw 100 in an operational position. For example, ‘front’ refers to the leading end of the circular saw 100 where the saw blade makes cuts and ‘rear’ refers to the end of the saw opposing the leading end, facing an operator. FIGS. 1-6 provide legends for these operational directions.

Circular saw 100 is configured to rotate a saw blade (not pictured) via an output shaft 157 (see FIGS. 11, 12), as described below. The saw blade is housed inside the blade housing assembly 105 that includes an upper blade housing (sometimes referred to as an upper blade guard) 106 and a lower blade guard 107. The upper blade housing 106 may be shaped as a partial-circle or a semi-circle to conform to the shape of the saw blade. The lower blade guard 107 may also be shaped as a partial-circle or a semi-circle in shape and operable to pivot or retract into the upper blade housing 106 when operated to expose the rotating saw blade therein to a workpiece.

The motor housing 153 protects, supports, and provides ventilation for at least one motor, for example a motor 102A, which is operable to rotate the output shaft 157 (see FIG. 11) via a transmission 152.

In an example, the motor 102A may be a Brushless Direct-Current (BLDC) motor. In an example, the circular saw 100 may include a plurality of motors 102. In the example described in the present disclosure, the circular saw 100 includes two motors 102A and 102B that cooperate to drive a master gear 118, as further described below. This is not intended to be limiting, however, in further examples the circular saw 100 may include any number of motors. A multi-motor drive unit 150 and the transmission 152 of the circular saw 100 will be described in more detail with respect to FIGS. 11-20.

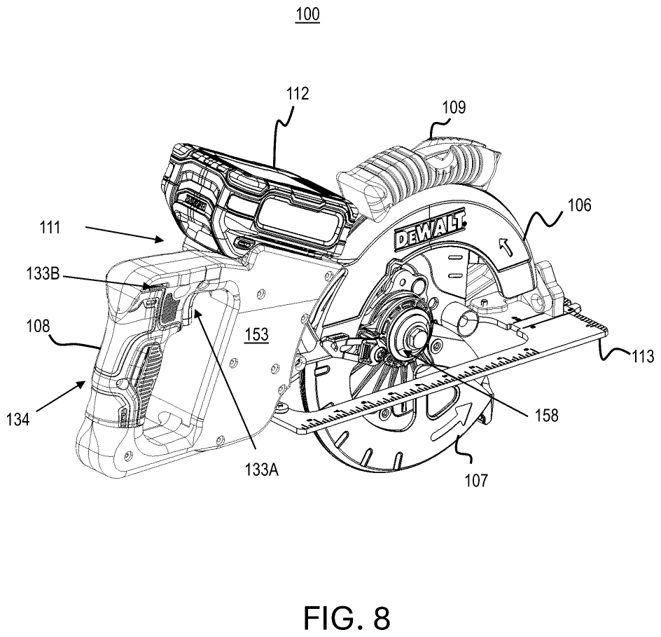

The handle assembly 108 may include a trigger 108E and a grip 134 (see FIG. 8). The trigger 108E may be engaged to operate the motor 102A. A user's first hand may grip the handle assembly 108 while a user's second hand may engage a stabilizing (sometimes referred to as secondary) handle 109 to operate the circular saw 100. The stabilizing handle 109 may be coupled to the upper blade housing 106, as will be further described below. In embodiments, the circular saw 100 may be used ambidextrously. In other words, the handle assembly 108 may be used by a user's right hand and the stabilizing handle 109 may be used by a user's left hand or the handle assembly 108 may be used by a user's left hand and the stabilizing handle 109 may be used by a user's right hand. In embodiments, the stabilizing handle 109 may be pivotable or otherwise movable to facilitate ambidextrous use.

The shoe 113 is a substantially planar surface that may help maintain a bevel orientation (i.e., a non-90 degree alignment) between a vertical plane of symmetry 155 (see FIGS. 1, 3, 5, and 6) and a plane including the substantially planar surface of the shoe 113. The saw blade, when attached to the circular saw 100, resides in the vertical plane of symmetry 155. As such, the vertical plane of symmetry 155 may also be referred to as a saw blade plane. The shoe 113 comes to rest on a work piece during a cut and helps maintain alignment between the circular saw 100 and the work piece. The shoe 113 includes a slit for the rotating saw blade that bifurcates the shoe 113 into a left portion and a right portion.

In the exploded diagrams of FIGS. 11 and 12, the motor/transmission housing 153 may be seen. In an example, the motor/transmission housing 153 may include a left cover 114 and a right cover 115. The left cover 114 and the right cover 115 may couple to a gear and motor adapter 116 to form the motor/transmission housing 153. The gear and motor adapter 116 may provide support and alignment for the plurality of motors 102 and the transmission 152, which may include the master gear 118, two pinions 117, an input pulley 119, and an output pulley 120, as will be further described below. In an example, the gear and motor adapter 116 may support the plurality of motors 102 on a first side and the transmission 152 on a second side. For example, the gear and motor adapter 116 may support the plurality of motors 102 on a right side, to be covered by the right cover 115, and the gear and motor adapter 116 may support the transmission 152 on the left side, to be covered by the left cover 114. This may divide the right portion of the transmission housing 153 into a motor housing portion and the left portion of the transmission housing 153 into a transmission housing portion.

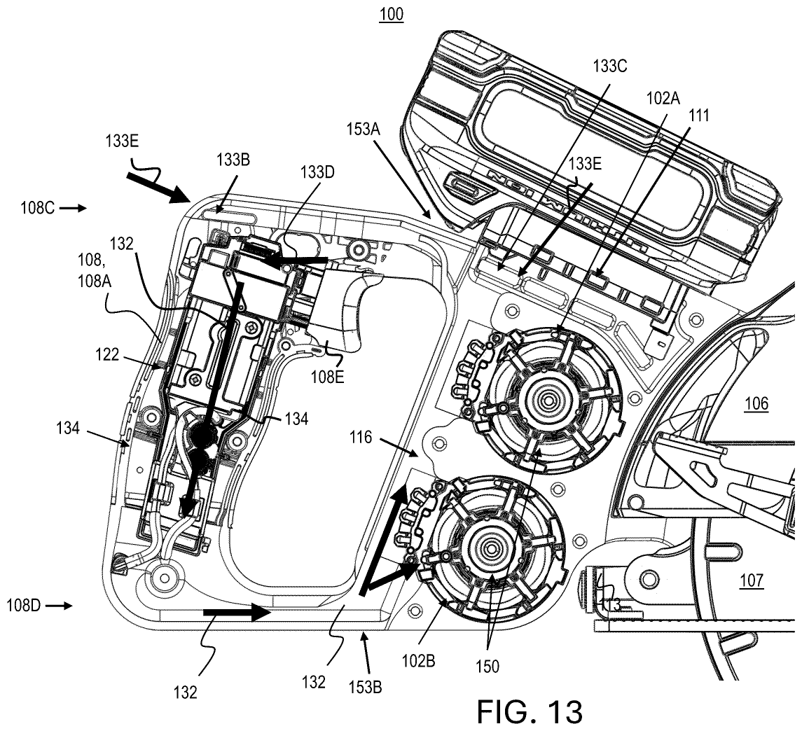

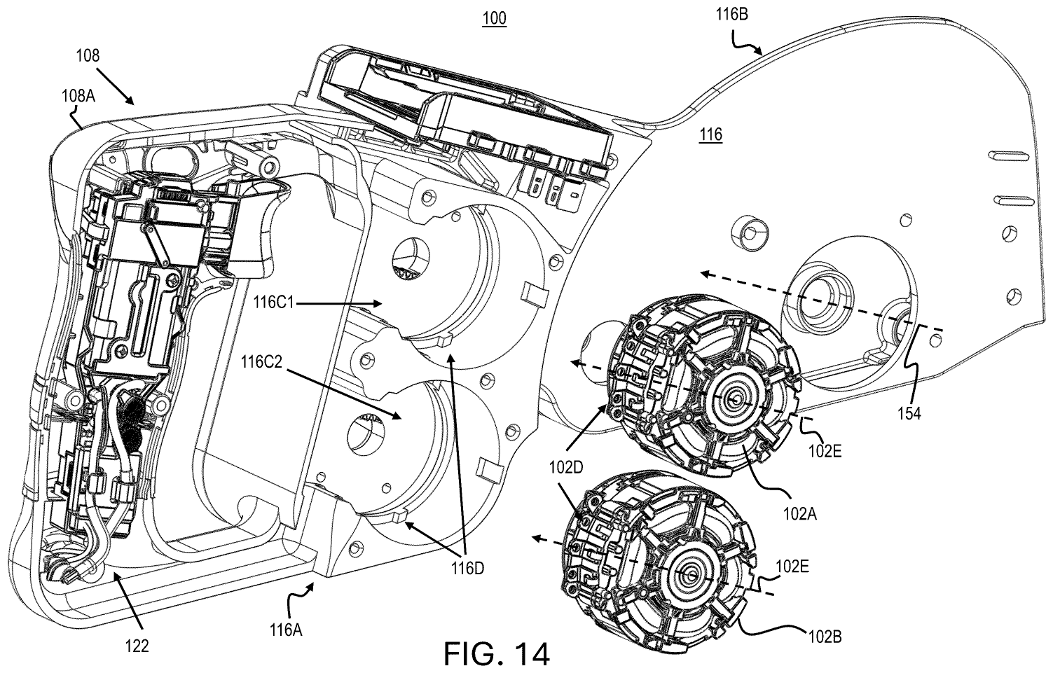

FIG. 13 depicts a view of the gear and motor adapter 116, the first motor 102A, and the second motor 102B. FIG. 14 depicts a view of the gear and motor adapter 116 wherein the first motor 102A and the second motor 102B have been exploded out. In an example, the gear and motor adapter 116 may be integrated with the handle assembly 108 at a first end 116A of the gear and motor adapter 116. In an example, the first end 116A may be integrated with any portion of the handle assembly 108, such as a left handle assembly cover 108A. The gear and motor adapter 116 may include a second end 116B that couples to the blade housing assembly 105.

The plurality of motors 102 may be positioned to the rear of the circular saw 100, for example between the handle assembly 108 and the blade housing assembly 105. In an example, the motor 102A and the motor 102B may each be positioned in a motor receptacle (sometimes referred to as a motor cavity) 116C1, 116C2, which may be a raised area with indentations to seat motors within the gear and motor adapter 116 (see FIG. 14). The motor receptacles 116C1, 116C2 may be integral to or separate from the gear and motor adapter 116.

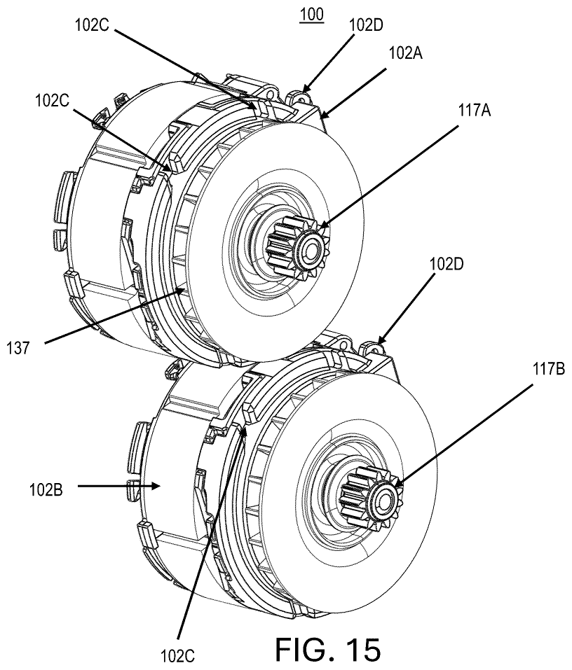

FIG. 14 depicts the motor receptacles 116C1, 116C2, the first motor 102A, and the second motor 102B from the right perspective and FIG. 15 depicts the first motor 102A and the second motor 102B from the left perspective. In FIG. 14, it may be seen that each of the motor receptacles 116C1, 116C2 may include one or more tabs 116D. Referring to FIG. 15, it may be seen that each motor may include one or more indentations 102C that corresponds to each tab 116D. The indentation 102C and tab 116D may cooperate when the circular saw 100 is assembled to provide alignment of the plurality of motors 102 within the gear and motor adapter 116 and therefore the circular saw 100.

As may be seen in FIG. 14, the first motor 102A and the second motor 102B may each have a rotational axis 102E that is parallel to a rotational axis 154 of the output shaft 157. In an example, each of the first motor 102A and the second motor 102B may be positioned at approximately the same radial distance from the output shaft rotational axis 154 towards the rear of the circular saw 100. The plurality of motors 102 may be positioned towards the rear of the circular saw 100 between the handle assembly 108 and the upper blade housing 106 in the area under the left cover 114.

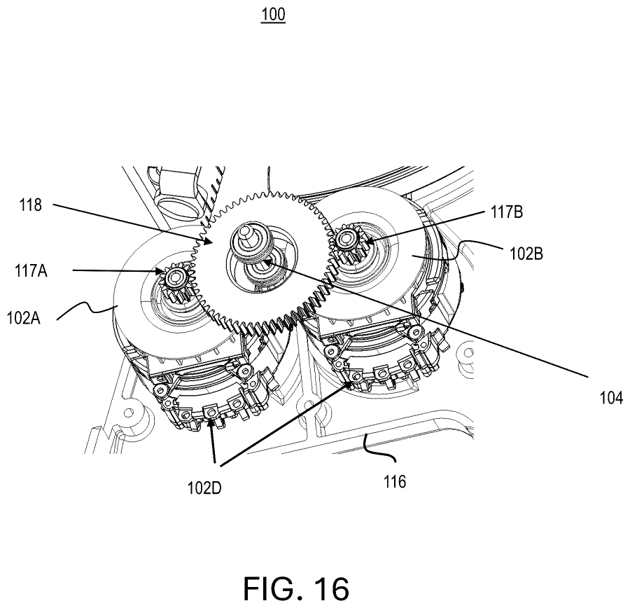

Turning to FIGS. 15 and 16, each respective motor of the plurality of motors 102 may include a plurality of motor terminals 102D oriented towards the rear of the circular saw 100. By orienting the motor terminals 102D towards the rear of the circular saw 100, it may be easier to couple the motor terminals 102D to a motor electronics module 122 inside of the handle assembly 108.

In an example, a left-right center of mass of each of the plurality of motors 102 may reside in the plane of symmetry 155 (see FIGS. 1, 3, 5). By having the left-right center of mass of each of the plurality of motors 102 residing in the plane of symmetry 155 it may be possible to make a width 156 (see FIG. 1) of the circular saw 100 narrower than prior saws along the output shaft rotational axis 154. The narrower circular saw profile may facilitate ambidextrous use of the circular saw 100. The narrow profile may further allow an operator to cut a workpiece that is even closer to a wall. In embodiments, the narrower profile of the circular saw 100 may further allow for the shoe 113 to be movable into a dual-sided bevel position.

The left handle assembly cover 108A and right handle assembly cover 108B may be coupled together to form the handle assembly 108, which may protect the motor electronics module 122. In examples, the left handle assembly cover 108A may be integrated into the gear and motor adapter 116. In examples, the right handle assembly cover 108B may be integrated into the right cover 115. In examples, the gear and motor adapter 116 may comprise a substantially integrated piece or include one or more sections coupled together.

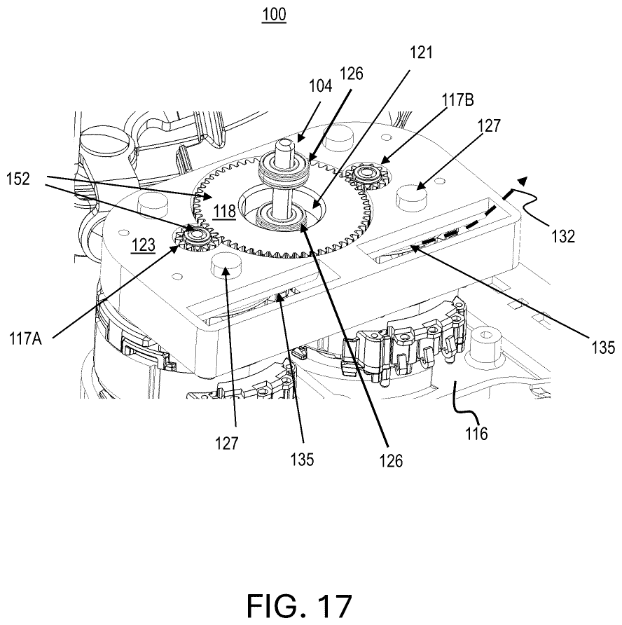

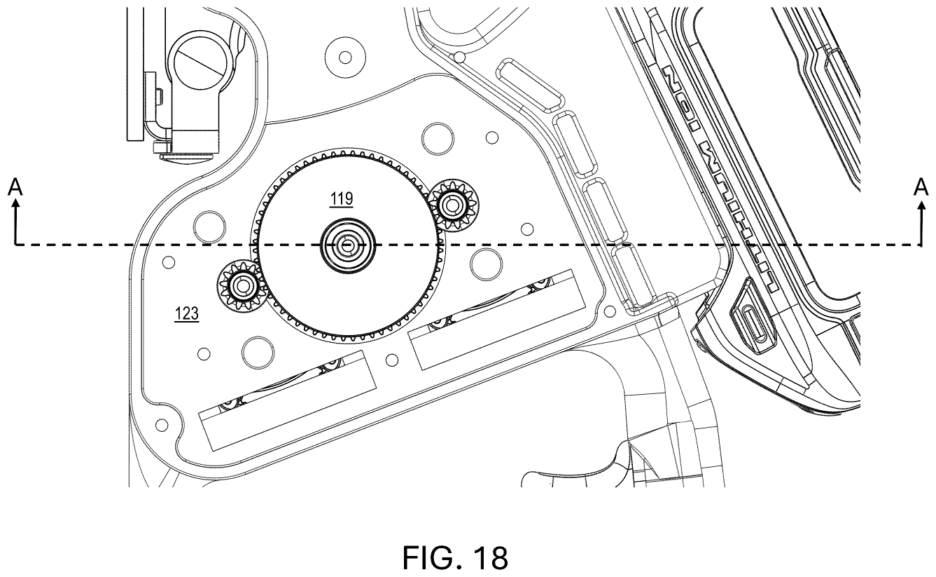

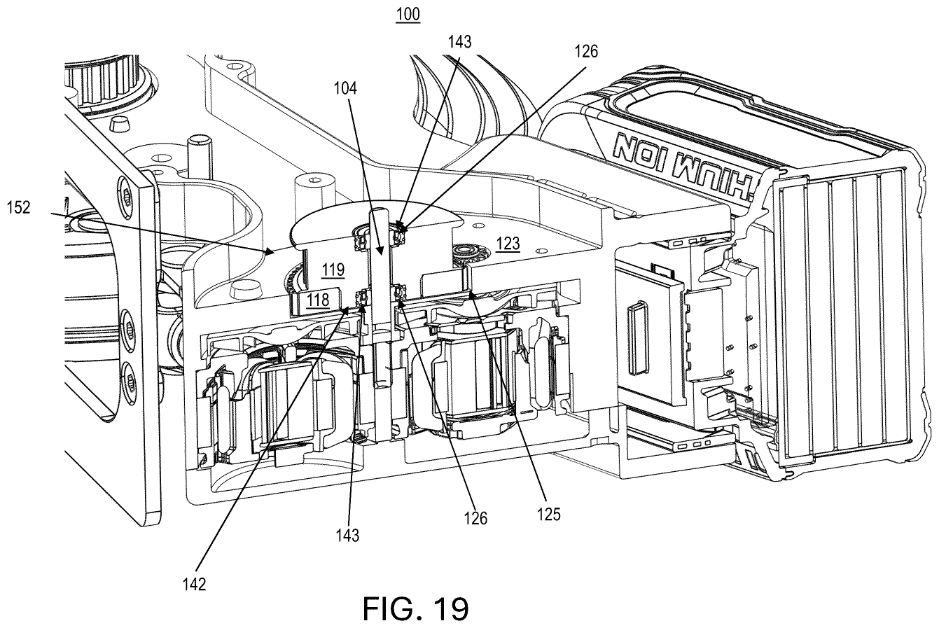

The circular saw 100 includes the transmission 152. FIGS. 16 and 17 depict how the motor 102A and the motor 102B may transfer torque to the master gear 118. The motor 102A and the motor 102B may each rotate a respective motor output shaft coupled to a respective planet gear (a pinion 117A and a pinion 117B). Each of the two pinions 117 engage the master gear 118. FIGS. 18 and 19 provide views that include the input pulley 119. The input pulley 119 may be rigidly coupled to the master gear 118 so that as the motor 102A and the motor 102B transfer torque to the pinions 117A, 117B, respectively, and the pinions 117A, 117B transfer torque to the master gear 118, the input pulley 119 is rotated about input pulley rotation axis. In an example, the two pinions 117 and the master gear 118 may be straight cut gears. The two pinions 117 and the master gear 118 may achieve a mechanical reduction.

FIG. 17 depicts the two pinions 117 and the master gear 118 positioned inside a gear sleeve 123, which may be integral to or separately coupled to a side of the gear and motor adapter 116 opposing the motor receptacles 116C1, 116C2. The gear sleeve 123 may help provide support for the stationary shaft 104 on a right most end of the stationary shaft 104. As may be seen in FIG. 12, the gear sleeve 123 may include a seat 125 that may accommodate the master gear 118 and a through hole that may receive and hold an end of the stationary shaft 104. The master gear 118 may include a central, cylindrical cavity 121.

As may be seen in FIGS. 12 and 17, the gear sleeve 123 may include one or more bosses 127. In an embodiment, there may be four bosses, for example. The one or more bosses 127 may be used to align, couple, and/or nest with companion features on the pulley cap 131, as may be seen in FIG. 12.

The pulley cap 131 may be coupled to the gear sleeve 123 to help support a second end of the stationary shaft 104, thereby securing the transmission 152 to the body of the gear and motor adapter 116. In examples, a fastener 131F (see FIG. 12), for example a screw, may further secure the pulley cap 131 to the stationary shaft 104.

FIG. 18 includes a plan view of the components of FIG. 17 with the addition of the input pulley 119, and FIG. 19 depicts the cross-sectional view along section line A-A of FIG. 18. In the example, the input pulley 119 may include a cylindrical extension 142 that is received in the cylindrical cavity 121 of the master gear 118. In examples, the input pulley 119 may be press-fit into the master gear 118. Two or more bearings 126 (see FIGS. 17 and 19) may create a rotatable coupling between the stationary shaft 104 and the input pulley 119. The two or more bearings 126 may be seated within one or more bearing seats 143 of the input pulley 119 (see FIGS. 11 and 19).

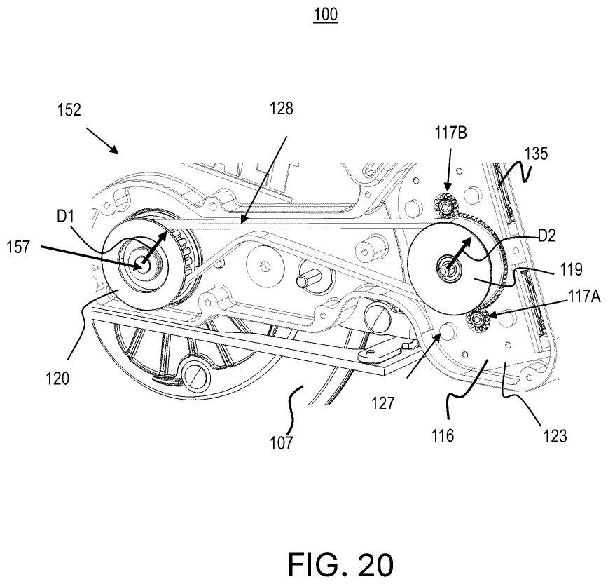

A view of the transmission 152 may be seen in FIG. 20. The transmission 152 transfers motive power from the input pulley 119 to the output pulley 120 via a timing belt 128. In an example, the timing belt 128 may be a toothed timing belt positioned around and engaging one or more teeth around the input pulley 119. The timing belt 128 may provide shock-absorbing benefits to transmission 152.

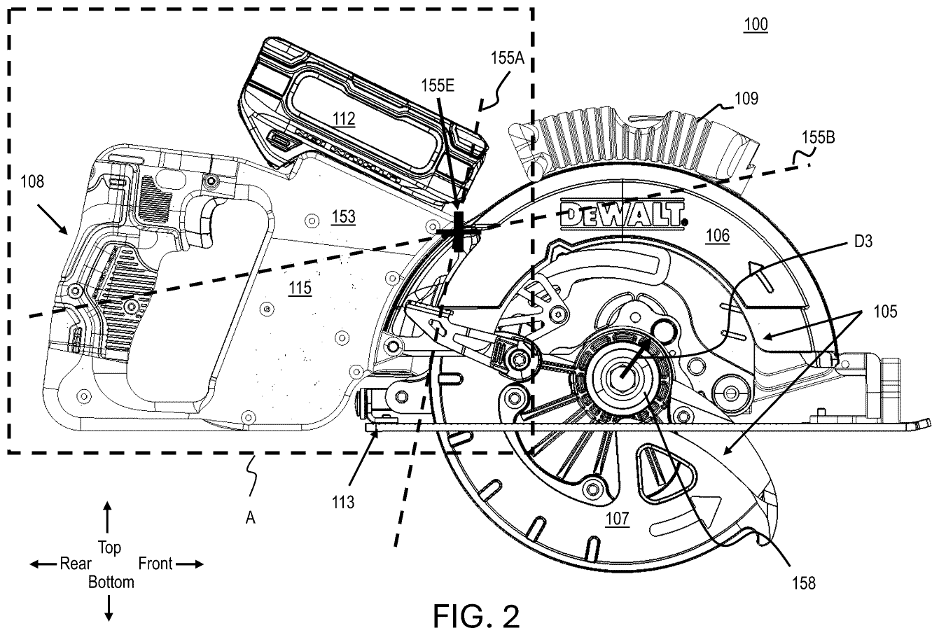

In an embodiment, the output pulley 120 may have a diameter D1 that is less than a diameter D2 of the input pulley 119. The diameter D1 of the output pulley 120 being less than the diameter D2 of the input pulley 119 may be possible because the gearing on the circular saw 100 is reduced early in the drive train via the two pinions 117 and the master gear 118. The diameter D1 being less than the diameter D2 may speed up the rotation of the output pulley 120 and the rotating saw blade. The diameter D1 being less than the diameter D2 may also allow for a for a larger depth of cut, especially if the diameter D1 is less than a diameter D3 (see FIG. 2) of a flange 158 coupling the saw blade to the output shaft 157. In an example, the transmission 152 may achieve at least a 4:1 gear reduction. In an example, the transmission 152 may achieve at least a 4.61:1 gear reduction.

In an example, the transmission 152 may provide for a faster output drive element rotation speed, and therefore a faster saw blade speed. In an example, the output drive element rotation speed may be at least 6000 revolutions per minute (RPM) or 6500 RPM. In an example, the output drive element rotation speed may be 6850 RPM or greater.

There may be a strong desire to increase the depth of cut of the circular saw 100 over prior circular saws. Prior circular saws provide a 2.5625 cm depth of cut for a for a blade size varying from 18.3388 cm to 20.32 cm. Increasing the depth of cut is strongly desired. One of the biggest challenges to getting increased depth of cut is the diameter of the output drive element on output shaft 157.

Reducing the gearing on the circular saw 100 early with the two pinions 117 and the master gear 118 and the diameter D1 of the output pulley 120 being less than the diameter D2 of the input pulley 119 may further allow for the diameter D1 of the output pulley 120 to be less than or equal to the diameter D3 of the flange 158, enabling a greater depth of cut over prior circular saws. In an example, the saw blade may include a blade diameter of 18.3388 cm, enabling a depth of cut of at least 2.5625 cm. In an example, the saw blade may include a blade diameter of 18.3388 cm, enabling a depth of cut of at least 7.14375 cm. In an example, the output pulley 120 may have a diameter D1 that is less than or equal to approximately 20% of a saw blade diameter of the saw blade. In an example, the output pulley 120 may have a diameter D1 that is less than or equal to approximately 16.5% of a saw blade diameter of the saw blade.

Turning to FIG. 13, the handle assembly 108 may be coupled to the motor/transmission housing 153, which may include a top handle end 108C coupled to a top portion 153A of the motor/transmission housing 153 and a second handle end 108D coupled to a bottom portion 153B of the motor/transmission housing 153. A space between the handle assembly 108 and motor/transmission housing 153 may allow for an operator to insert a hand to embrace the handle assembly 108 via a grip 134. The motor/transmission housing 153 may enclose any portion of the transmission 152, the motor 102A, and the motor 102B. In an example, the motor electronics module 122 may be positioned inside the handle assembly 108 between the top handle end 108C and the second handle end 108D.

A cooling path 132 is an air path through the circular saw 100. The cooling path 132 may be configured to cool any combination of the plurality of motors 102 and/or the motor electronics module 122. In embodiments, the cooling path 132 may be passive or active. For example, air traveling along the cooling path 132 may be driven by fans internal to the multi-motor drive unit 150, for example a fan 137 (see FIG. 15).

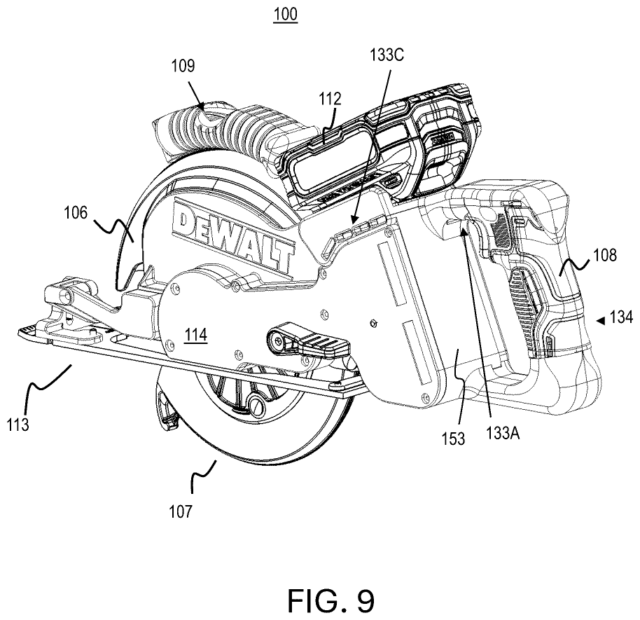

In an example, the cooling path 132 may begin with an air inlet 133A positioned just above or adjacent to the trigger 108E (see FIG. 9, and air flow 133D represented by an arrow in FIG. 13) on the handle assembly 108. In an embodiment, an air inlet 133B may be positioned in the top handle end 108C (see FIG. 8, and air flow 133E represented by an arrow in FIG. 13) of the handle assembly 108. In an embodiment, an air inlet 133C may be positioned in or adjacent to a battery receptacle 111 (see FIG. 8, and air flow 133E represented by an arrow in FIG. 13) in the motor/transmission housing 153.

In an example, the air flowing along the cooling path 132 may enter top handle end 108C from the motor/transmission housing 153 via an inlet (not depicted) positioned adjacent to the motor 102A and continue flowing towards the rear of the handle assembly 108 into the grip 134. The air flowing along the cooling path 132 may next descend through the grip 134, past the motor electronics module 122, and circulate towards the front of the circular saw 100 via the second handle end 108D. The air flowing along the cooling path 132 may then enter the gear and motor adapter 116 and move towards the top of the circular saw 100 to the rear of the motor 102A and the motor 102B. The air flowing along the cooling path 132 may then pass through any combination of the plurality of motors 102. In an example, the airflow along the cooling path 132 may be assisted by a respective fan 137 integral to the plurality of motors 102. The air flowing along the cooling path 132 may then emerge on the opposing side of the gear and motor adapter 116.

Air in the cooling path 132 may next exit one or more exhaust vents, for example via the exhaust vent 135 in the gear sleeve 123, as depicted in FIGS. 17 and 20. In an example, the exhaust vent 135 may be adjacent to at least one of the plurality of motors 102 in the motor/transmission housing 153 or the gear sleeve 123. The air flowing along the cooling path 132 may continue through one or more vents 138 in the pulley cap 131 and one or more vents 139 in the left cover 114 to exit the circular saw 100 (see FIG. 12).

In a further example, a cooling path may circulate air in an opposite direction to the cooling path 132. For example, air flowing along the cooling path may enter adjacent to the second handle end 108D, move up through the grip 134 and into the top handle end 108C. In other examples, combinations of inlets and outlets may be positioned in other portions of the motor/transmission housing 153 or the handle assembly 108 to facilitate a cooling path that traverses a length of the grip 134 between the top handle end 108C and the second handle end 108D in either direction. The cooling path may traverse any combination of the plurality of motors 102 and the motor electronics module 122 to provide cooling to the circular saw 100.

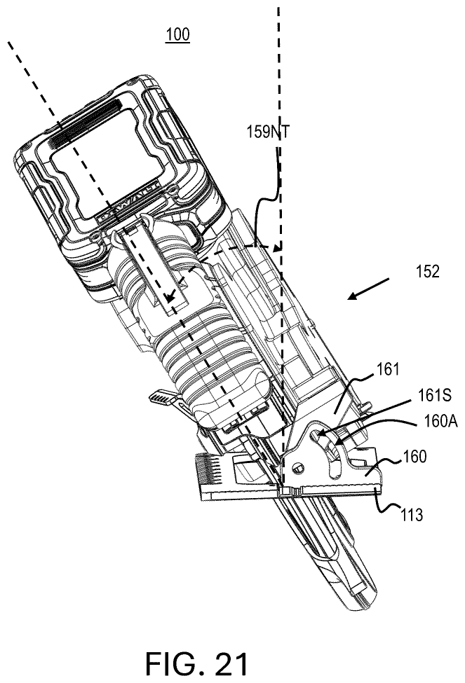

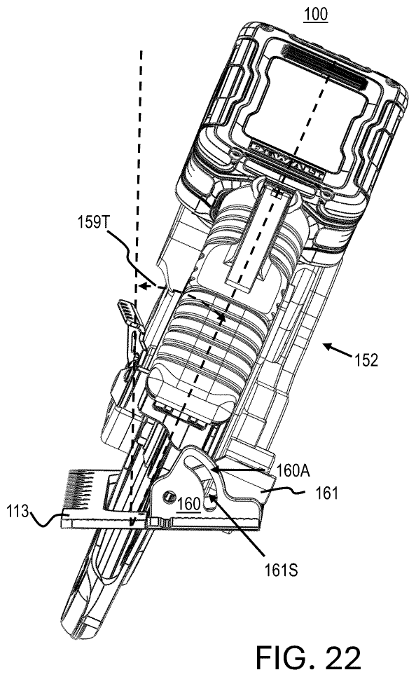

Prior circular saws with side-by-side saw blade and motor configurations are typically only able to bevel in one direction opposite the motor and transmission. FIGS. 21 and 22 depict a front view of the circular saw 100 positioned to make bevel cuts in two directions, according to an example. In order to execute a bevel cut, typically an operator will adjust the shoe 113 to a desired angle to the plane of symmetry 155 so that a planar surface of the shoe may come into contact with a workpiece at the desired angle. To set the bevel angle, an operator may use a pivot block 160 and a pivot roller 161 to set an angle for the shoe 113, discussed below.

In FIG. 21, it may be seen that the circular saw 100 may be able to achieve a non-transmission side bevel angle 159NT of at least 52 degrees. In other examples, however, the circular saw 100 may be able to achieve a non-transmission side bevel angle 159NT between 45 and 60 degrees.

The circular saw 100 may have one or more motors 102 positioned in the plane of symmetry 155, as described above. Placing the one or more motors 102 to the rear of the trailing edge of the saw blade (when the saw is in an operational position) may make room for the circular saw 100 to bevel in the direction of the transmission-side as well. As depicted in FIG. 22, the circular saw 100 may achieve a transmission side bevel angle 159T that is greater than zero.

In prior circular saws, the transmission may further prevent beveling in the direction of the transmission. Typically, circular saws include an output drive element adjacent to a flange that secures the saw blade to an output shaft. The size of the output drive element in prior circular saws prevents beveling in the direction of the non-transmission side of the saw blade. As described above, however, the circular saw 100 may gear down between the two pinions 117 and the master gear 118 and the output pulley diameter D1 may be less than the input pulley diameter D2. The transmission 152 may therefore enable the output pulley 120 to have a diameter D1 that is equal to or less than the diameter D3 (see FIG. 2) of the flange 158. The minimum diameter of the flange 158 size is typically limited by safety regulations (for example UL regulations) based on saw blade diameter. Therefore, the output drive element diameter (such as the output pulley 120) is limiting and making the output drive element diameter less than the flange diameter D3 may maximize the achievable transmission side bevel angle 159T (see FIG. 22). In an example, the transmission side bevel angle 159T may be at least 52 degrees. In other examples, however, the circular saw 100 may have a transmission side bevel angle 159T between 45 and 60 degrees.

FIGS. 21 and 22 further depict the pivot block 160 and the pivot roller 161. The pivot block 160 may be coupled to the shoe 113 and the pivot roller 161 may be coupled to at least one of the upper blade housing 106 or the motor/transmission housing 153. The pivot block 160 may include an arc segment 160A. The arc segment 160A depicts a range of travel for the shoe 113 as it angles to the transmission or the non-transmission side of the plane of symmetry 155. The pivot roller 161 may include a pivot roller slot 161S visible through the arc segment 160A. The position of the pivot roller slot 161S with respect to the arc segment 160A may indicate what angular position the shoe 113 is in. A lever with a carriage bolt (not depicted) may be inserted through the arc segment 160A to engage the pivot roller slot 161S and lock the shoe 113 at an angled position, thereby setting a bevel angle for a cut.

In prior saws, the pivot roller slot 161S is typically positioned at a first end or a second of an arc segment when a shoe is perpendicular to the rotational plane of the saw blade. The arc segment 160A and the pivot roller slot 161S may be configured to place the pivot roller slot 161S in the middle of the arc segment 160A when a predominantly planar surface of the shoe 113 is oriented to be perpendicular to the axis of symmetry 155 (in other words, when the shoe 113 is set to not make a bevel cut). This may enable the operator to preset the bevel angle across the entire two directional bevel range.

In an example, the shoe 113 may be operable to tilt at bevel angles between −45 and 45 degrees with respect to the plane of symmetry 155. In an example, the shoe 113 may be operable to tilt at bevel angles between −52 and 52 degrees with respect to the plane of symmetry 155. In examples, the circular saw 100 may be operable to make bevel cuts from −45 to 45 degrees or −52 to 52 degrees.

In an example, the plurality of motors 102 and the transmission 152 may allow for the motor/transmission housing 153 to have narrower dimensions from left to right (in the direction of the output shaft rotational axis 154) between the plane of symmetry 155 and an end of the motor/transmission housing 153 in the transmission direction along a length L1 (see FIG. 1). In an example, the length L1 may be 6.1 cm or less. Beyond enabling a dual bevel feature, the shorter dimensions of the length L1 may allow an operator to make closer cuts to a wall or other obstacle on the transmission side of the circular saw 100 over prior circular saws.

Prior circular saws with typical side-by-side motor and saw blade configurations featured a center of mass that was far outside the plane of symmetry 155. Because prior saws also featured primarily large, heavy motors, those saws tended to be particularly imbalanced from left to right when held in an operational position. From the front to back the center of mass tended to be positioned close to the output shaft rotational axis. Therefore, when prior circular saws were held in an operational position, the center of mass tended to be much closer to a front handle and far from a rear handle, which made the saw feel like it was tipping forward when held.

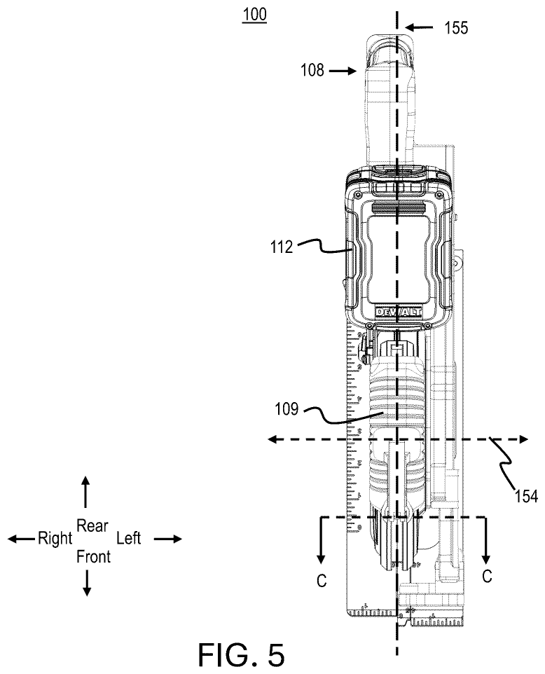

Turning to FIG. 5, it may be seen that, in an example, the circular saw 100 may include a center of mass—in a left-right direction—that resides in the plane of symmetry 155. Various components of the circular saw 100 may be positioned to facilitate the alignment of the plane of symmetry 155, as is further described below.

In examples, the battery receptacle 111 coupled to the motor/transmission housing 153 may include a battery receptacle center of mass—in a left-right direction—that resides on the plane of symmetry 155. As may be seen in FIG. 1, the battery receptacle 111 is centered—in the left-right direction—on the plane of symmetry 155.

In an example, the battery pack 112 may be coupled to the motor/transmission housing 153 with a battery pack center of mass—in a left-right direction—on the plane of symmetry 155. As may be seen in FIG. 1, the battery pack 112 is centered—in a left-right direction—on the plane of symmetry 155.

In an example, the handle assembly 108 may be positioned on a rear portion of the motor/transmission housing 153 so that a length L2 of the handle assembly 108 along a direction of output shaft rotational axis 154 is centered on the plane of symmetry 155. In an example, the handle assembly center of mass may be centered—in a left-right direction—on the plane of symmetry 155.

In an example, the shoe 113 may be coupled to the upper blade housing 106 so that the shoe center of mass is centered—in the left-right direction—on the plane of symmetry 155. In an example, the motor/transmission housing 153 may have a center of mass that is centered—in the left-right direction—on the plane of symmetry 155.

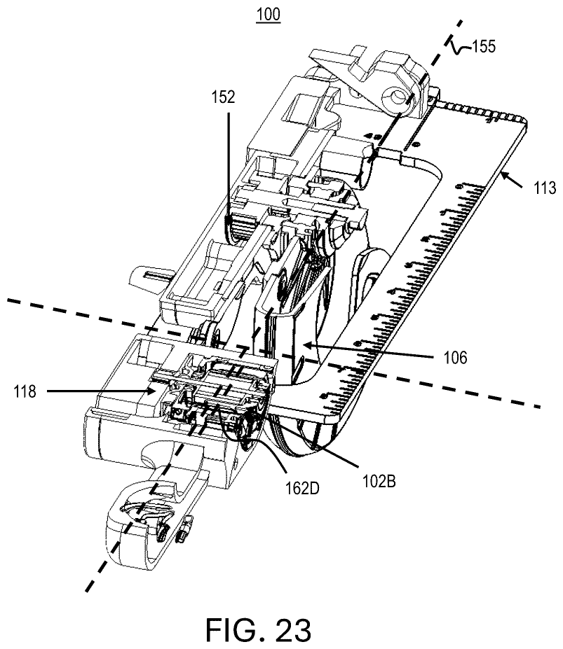

In an example, the transmission 152 and at least one motor may be offset from one another to balance a combined motor and transmission center of mass. For example, the transmission 152 may be positioned on at least one of a left side or a right side of the motor/transmission housing 153 and a motor of the plurality of motors 102 and the transmission 152 may have a combined motor-transmission center of mass that is substantially in the plane of symmetry 155. For example, FIG. 23 depicts a cutaway view of the circular saw 100 in which a cross-section of the upper blade housing 106, the shoe 113, and a cross section of the motor 102B may be seen. The transmission 152, which may include any combination of gears, pulleys, belt drive, and/or housing, is positioned to the left of the plane of symmetry 155 when the circular saw 100 is in an operational position. The motor 102B may be positioned with a motor radial line of symmetry 162D to the right of the plane of symmetry 155.

In an example, the motor radial line of symmetry 162D may not be centered in the axial direction due to the placement and relative weights of the stators, rotors, and/or fans within the motor. In an example, any combination of motors may be counterbalanced with the transmission 152 such that the center of mass of the combination of motor and transmission is on the plane of symmetry 155.

By locating the center of mass of any combination of the battery receptacle 111, the battery pack 112, the handle assembly 108, the shoe 113, or the combined motor and transmission on the plane of symmetry 155, it may be possible to increase the proximity of the center of mass of the circular saw 100 to the plane of symmetry 155 so that the center of mass of the circular saw 100 substantially aligns with the plane of symmetry 155. By substantially aligns, what may be meant is that the center of mass of the circular saw 100 is substantially within 0-3 mm of the plane of symmetry 155, in a left-right direction. Aligning the center of mass of the circular saw 100 with the plane of symmetry 155 may allow for a more intuitive feel for the circular saw 100, and further enable ambidextrous use.

Turning to FIG. 2, it may be seen that along the plane of symmetry 155, the circular saw 100 may have two intersecting lines of symmetry: a generally vertical line of symmetry 155A (hereinafter, simply referred to as the vertical line of symmetry) and a generally horizontal line of symmetry 155B (hereinafter, simply referred to as the horizontal line of symmetry). The center of mass 155E may be positioned at the intersection of the vertical line of symmetry 155A and the horizontal line of symmetry 155B, which may be between the handle assembly 108 and the stabilizing handle 109. When the plurality of motors 102 are positioned between the handle assembly 108 and the upper blade housing 106, it is possible to bring the center of mass 155E further behind of the leading edge of the saw blade so that the center of mass 155E is more centered between the operator's hand that is on the handle assembly 108 and the operator's hand that is on the secondary handle 109 when the circular saw 100 is in use. This may provide a more intuitive feeling for the operator because the fall-line of the circular saw 100 may be used to make plunge cuts.

Prior circular saws, especially those with side-by-side large motor and saw blade configurations, typically feature an asymmetric shoe with a much larger surface under the motor side of the saw blade versus the non-motor side of the saw blade to provide increased support for the weight of the motor against the workpiece. The skewed asymmetry of prior circular saw shoes provides more frictional force on one side of the blade than the other. The asymmetrical forces across the shoe can cause the saw to turn slightly when in use, thereby requiring an operator to make more careful use of cut guides.

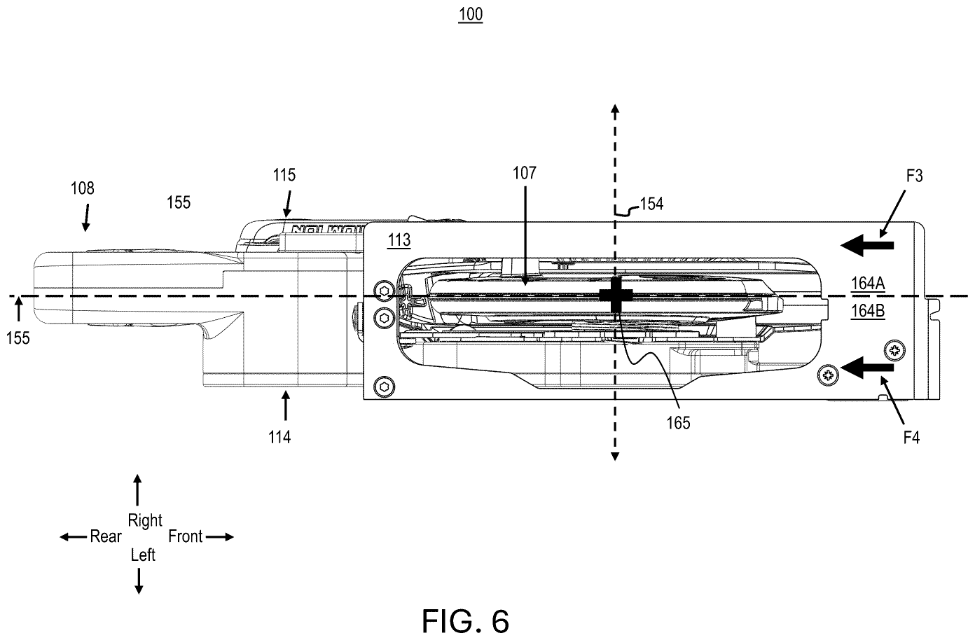

Turning to FIGS. 1 and 6, the circular saw 100 may include a shoe 113 that is bifurcated by the plane of symmetry 155 into a first portion 164A and a second portion 164B. A first force F1 applied via the first portion 164A to a workpiece may be substantially equal to a second force F2 applied via a second portion 164B of the shoe to the workpiece. By balancing the forces F1, F2 applied via the first portion 164A and the second portion 164B, it may be possible to generate a friction pivot point 165 that is centered on the plane of symmetry 155. In examples, it may be further possible to center the friction pivot point 165 on the output shaft rotational axis 154. Furthermore, a third force F3 applied along the first portion 164A to a workpiece (to overcome forces between the saw blade and the workpiece and frictional forces between the first shoe portion and the workpiece) may be substantially equal to a fourth force F4 applied along the second portion 164B to the workpiece (to overcome forces between the saw blade and the workpiece and frictional forces between the second shoe portion and the workpiece). By balancing the forces F3, F4 applied along the first portion 164A and the second portion 164B, it may be possible to generate a friction pivot point 165 that is centered on the plane of symmetry 155.

In an example, the first portion 164A of the shoe 113 may have a first surface area and the second portion 164B of the shoe 113 may have a second surface area, and a difference between the first surface area and the second surface area is less than 0.1 cm². In an example, the difference between the first surface area and the second surface area is less than 0.5 cm² or 0.3 cm².

Prior circular saws feature stationary stabilizing handles. A stabilizing handle is used to provide a second point of contact for a user's second hand on a circular saw, in addition to the handle assembly to the rear of the saw blade that includes the motor trigger. Because prior circular saws typically include heavy motors positioned side-by-side with a rotating saw blade, creating a center of mass centered in the bulky motor instead of the saw blade, stabilizing handles in prior circular saws are coupled to the motor housing to the side of the saw blade. The rigid positioning of prior stabilizing handles may also make it difficult to use a circular saw in some applications. For example, a right-handed operator generally prefers a circular saw with a blade left configuration and will struggle to use a circular saw with a blade right configuration.

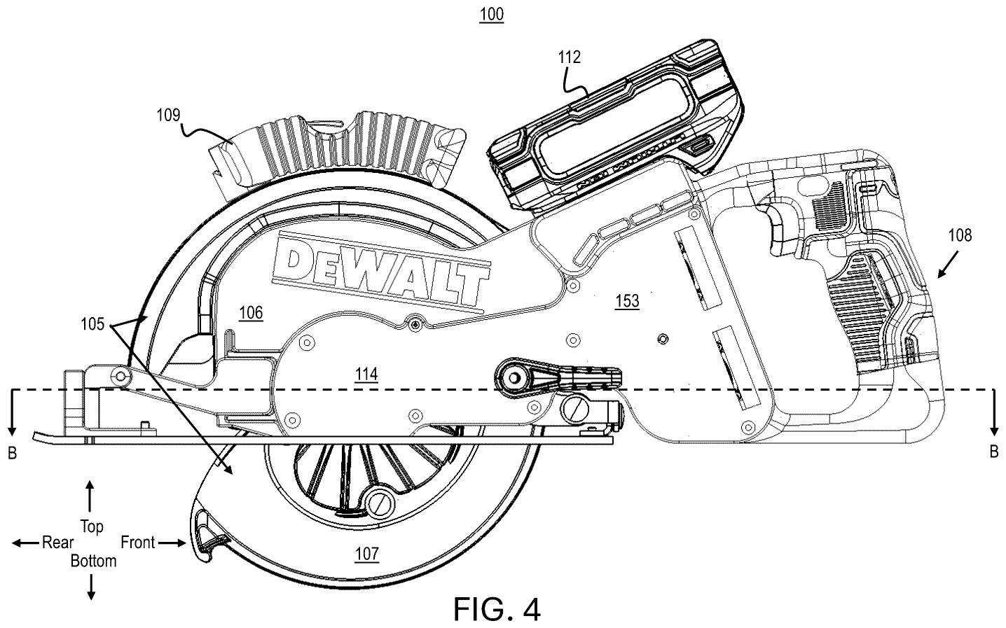

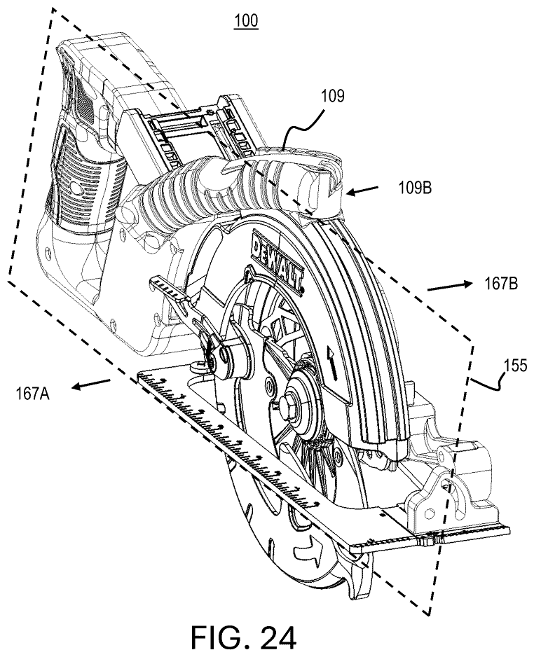

FIGS. 24-30 depict different views and details of the stabilizing handle 109. Along with handle assembly 108, the stabilizing handle 109 may be used by an operator to grip and guide the circular saw 100. In an example, the stabilizing handle 109 is coupled to a circumference of the upper blade housing 106. The upper blade housing 106 may have an upper circumference 106A in the shape of a section of a circle (semi-circular) surrounding the saw blade it houses. In an example, the stabilizing handle 109 may conform to the shape of the upper circumference 106A of the upper blade housing 106. For example, FIGS. 2 and 4 depict that the stabilizing handle 109 may be shaped to curve around the upper circumference 106A of the upper blade housing 106.

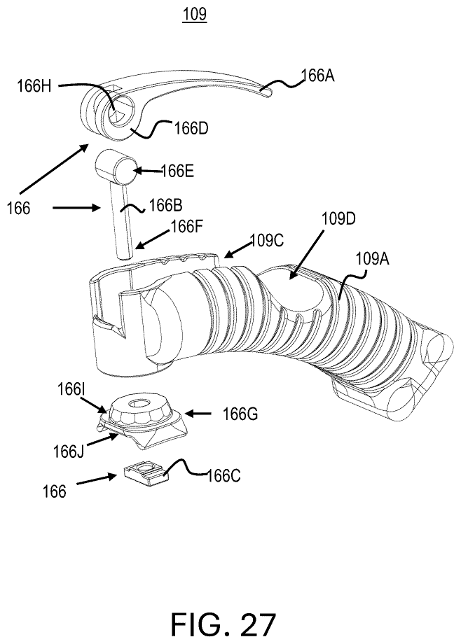

The stabilizing handle 109 may be coupled to the upper blade housing 106 via a fastener. In an example, the fastener may be a camming device 166, such as the one depicted in FIG. 27. The camming device 166 may include a cam lever 166A, a shaft 166B, and a nut 166C. The cam lever 166A may include a cam portion 166D that can be tightened against a surface within the handle (not depicted) within a stabilizing handle body 109A to secure the handle body 109A rigidly against the upper blade housing 106. The shaft 166B may include a head 166E configured to be inserted into an aperture 166H of the cam lever 166A. The shaft 166B may further include threads at a second end 166F to engage the nut 166C.

In an example, the stabilizing handle 109 may include an elongated indentation 109C to allow the cam lever 166A to nest into the stabilizing handle body 109A so that the cam lever 166A is not inadvertently opened during a cut operation. The stabilizing handle 109 may further include a fingertip cutout 109D to allow a user to access the tip of the cam lever 166A to open and close camming device 166.

The description of the camming device 166 is not intended to be limiting. In other examples, the fastener may comprise a simple knob with a captured nut, or any other type of fastener.

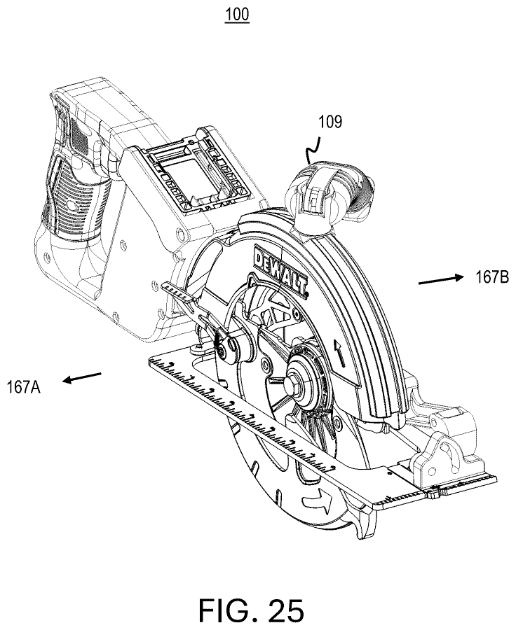

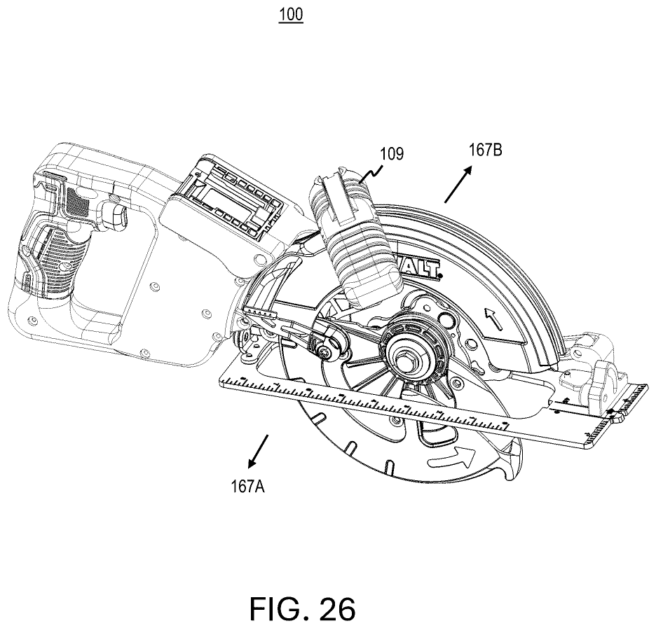

In an example, it may be possible to pivot the stabilizing handle 109 to a first side 167A (as illustrated in FIG. 26) of the plane of symmetry 155 or a second side 167B (as illustrated in FIG. 25) of the plane of symmetry 155 via a pivotable end 109B of the stabilizing handle 109. FIG. 5 depicts the stabilizing handle 109 in a position aligned with the plane of symmetry 155. FIG. 24 depicts the stabilizing handle 109 pivoted to rear and to the first side 167A, and FIG. 25 depicts the stabilizing handle 109 pivoted to the rear and the second side 167B. FIG. 26 depicts the stabilizing handle 109 pivoted to the front and the first side 167A. In an example, the stabilizing handle 109 may be able to pivot around a 360-degree range and be fixed for use at any point of the 360-degree range. The pivot feature may create convenience for the operator to use the circular saw 100 ergonomically in a greater variety of applications.

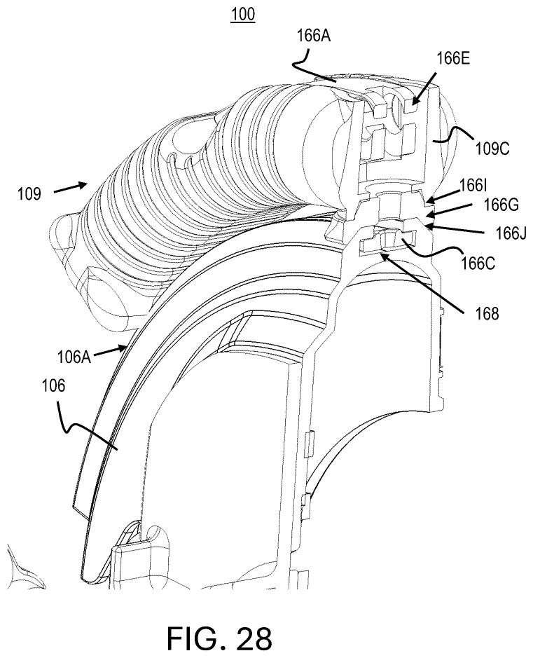

To change the angle or orientation of the stabilizing handle 109 with respect to the circular saw 100, the cam lever 166A may be lifted away from stabilizing handle 109 to loosen the fastener. Stabilizing handle 109 may then be pivoted to one side or the other of the plane of symmetry 155. As seen in FIG. 28, the camming device 166 may include a washer 166G to facilitate a range of pivot positions. In an example, the washer 166G may include castellated features that pair with receiving features on the underside of the stabilizing handle 109 (not pictured) to lock the stabilizing handle 109 into one of a predetermined set of rotational positions.

FIG. 28 depicts a section view of the circular saw 100 at cross-section line C-C, as indicated in FIG. 5. FIG. 28 depicts how the stabilizing handle 109 couples to the upper blade housing 106 with the camming device 166 (shaft 166B is not included in the figure for clarity). In the detail, a cross-sectional view of the washer 166G may be seen. The washer 166G may include a sliding contact surface 166J that contacts the upper circumference 106A of the upper blade housing 106 and a castellated surface 1661 in contact with the stabilizing handle 109. The nut 166C may also be seen in the figure.

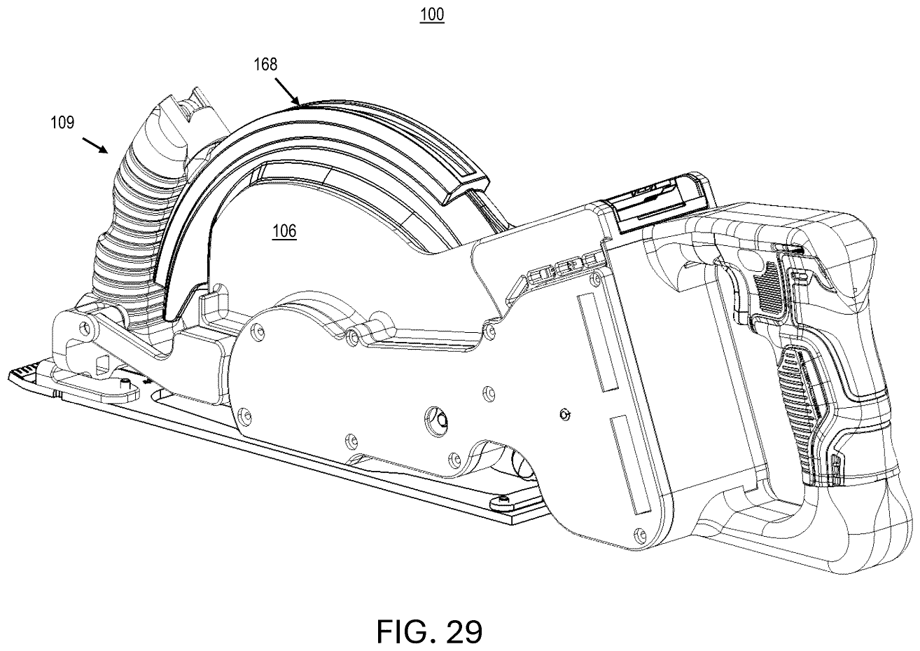

In an example, the upper blade housing assembly may include a track 168 along the upper circumference 106A operable to seat and translate the fastener that couples the handle to the circumference. In an example, the track 168 may be a T-shaped cross-sectional area operable to secure the nut 166C when the shaft 166B is turned to tighten the nut 166C against the track 168. The track 168 may allow the stabilizing handle 109 to translate forward and rearward along the upper circumference 106A. FIG. 29 depicts the stabilizing handle 109 translated towards the front of the circular saw 100 when the saw is in an operational position.

In order to translate the stabilizing handle 109 along the track, an operator may lift the cam lever 166A away from stabilizing handle 109 to loosen the nut 166C with respect to the interior surface of the track 168. Once the camming device 166 is loose, the stabilizing handle 109 may be moved forward or backward, sliding the nut 166C within track 168 while retaining the shaft 166B, and then the cam lever 166A may be pressed back into the elongated indentation 109C of the stabilizing handle 109 to secure the stabilizing handle 109 in the selected position.

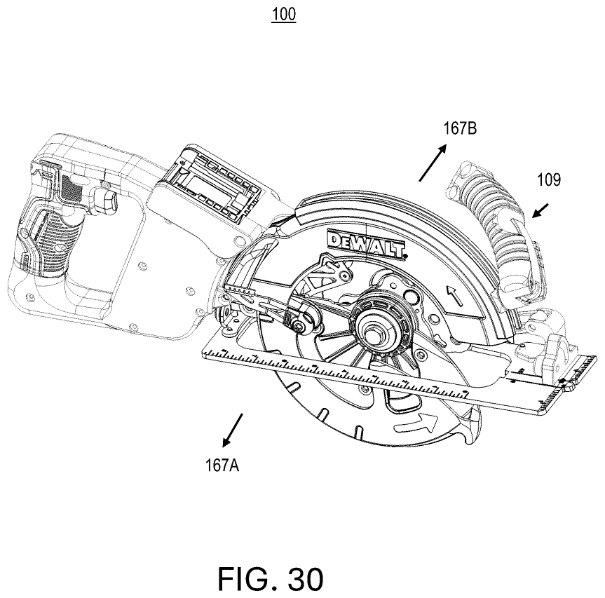

The circular saw 100 may include a combination of the pivoting and translating features. In an example, the stabilizing handle 109 may be translated and pivoted into any available position by loosening and re-tightening camming device 166. For example, FIG. 30 depicts the stabilizing handle 109 both translated towards the front of the circular saw 100 and pivoted to the second side 167B.

The features described with respect to the stabilizing handle 109 may allow for a configurable saw that can make a greater variety of cuts over prior saws.

Because prior circular saws primarily have side-by-side motor and saw blade configurations, the motor/transmission housing tends to be bulky and oddly shaped. Bulky motor/transmission housing leads to exterior tool packaging that is similarly bulky, makes poor use of space, and is difficult to package densely in a space like a shipping container.

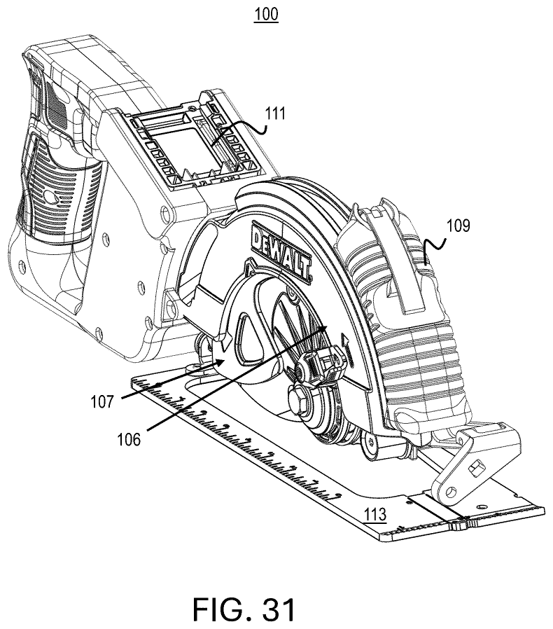

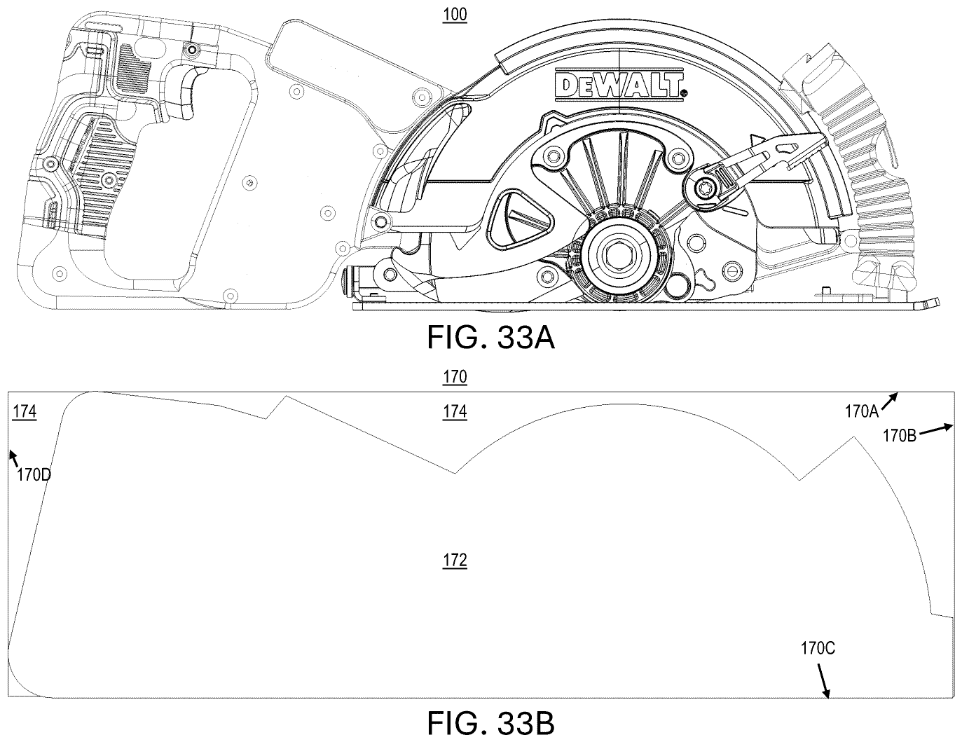

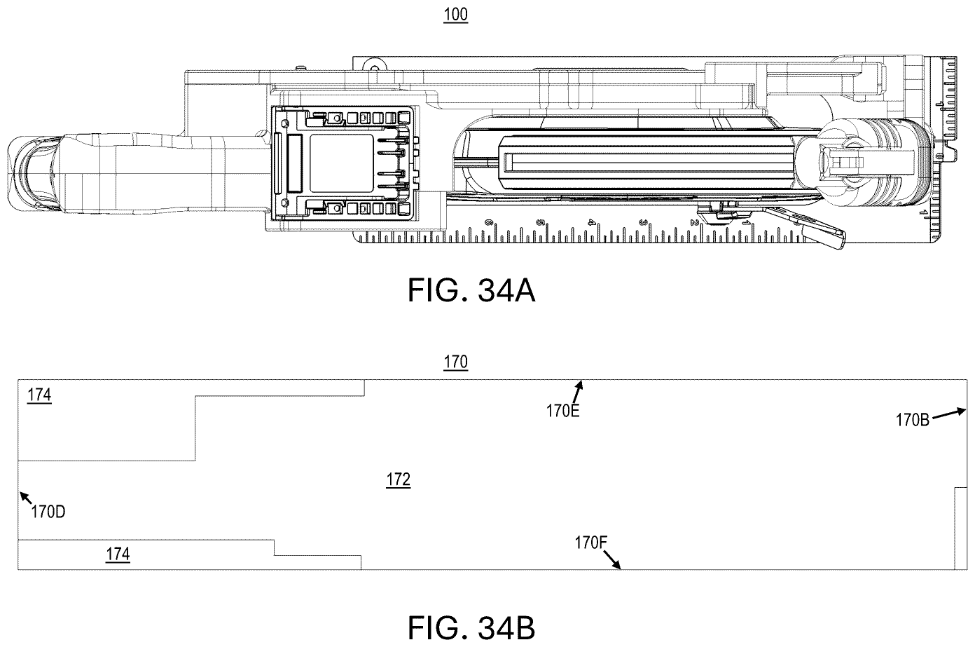

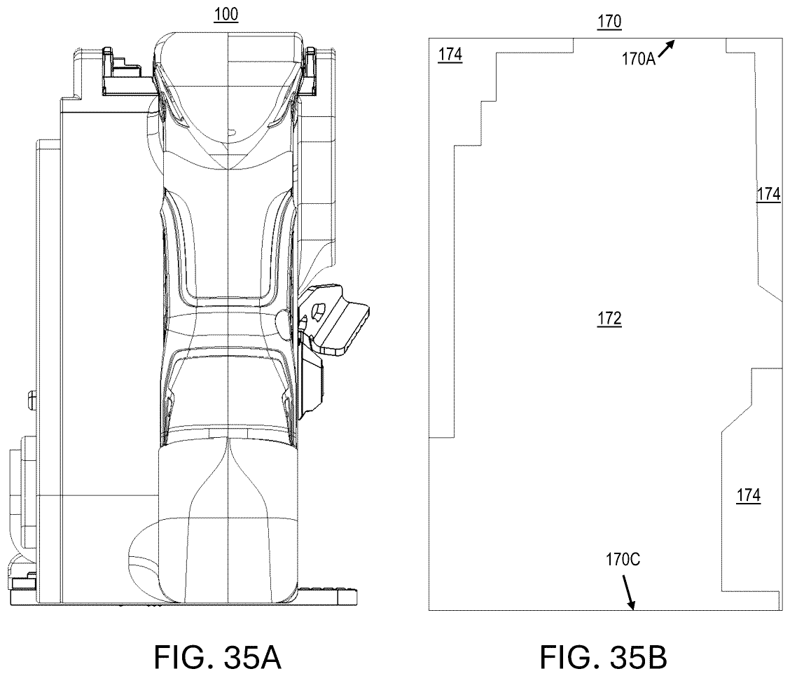

The various features of the circular saw 100 described above may enable a more efficient, compact design. Referring to FIGS. 31-35B, the volumetric size of the circular saw 100 may be expressed in multiple different manners. FIG. 31 illustrates a front, right, top isometric view of the circular saw 100 in a shipping position or state or configuration. In the shipping configuration, the stabilizing handle 109 is translated to a forward most position such that the handle body 109A is pivoted toward the front of the upper blade housing 106, the lower blade guard 107 is rotated to a fully open position—the lower blade guard is fully retracted into the upper blade housing 106 and above the shoe 113—a battery pack is not present in the receptacle 111 and a saw blade is not attached to the saw. In the shipping configuration, the circular saw 100 may be predominantly rectangular in shape, as illustrated in FIGS. 33A, 34A, 35A.

Referring to FIGS. 31, 33A, 34A, 35A, there is shown a first manner of expressing (or defining) a volume of the circular saw 100 (e.g., a displacement volume). FIGS. 31, 33A, 34A, 35A depict an isometric view and a right side elevation view, a top side plan view, and a rear side elevation view, respectively, of the circular saw 100, in the shipping configuration. As used herein, the displacement volume means the amount of three-dimensional (3D) space the entire circular saw takes up, as expressed in cubic units (e.g., cm³). The displacement volume may be measured using a displacement method, which measures a volume of water displaced when an entire, sealed circular saw is submerged in water. In an example embodiment, the circular saw 100 may have a displacement volume of approximately 1281 cm³ to approximately 1311 cm³. In an example embodiment, the circular saw 100 may have a displacement volume of 1296 cm³ or less.

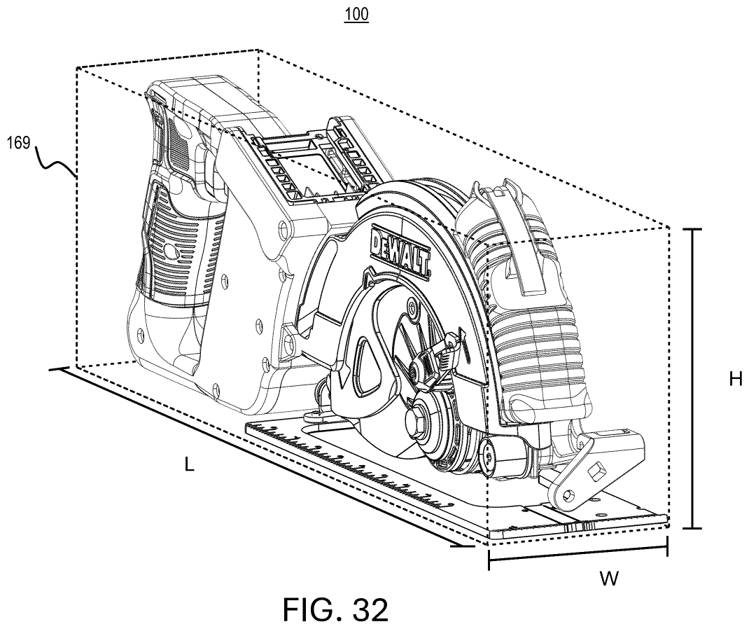

Referring to FIG. 32, there is shown a second manner of expressing (or defining) a volume of the circular saw 100 (e.g., a box volume). As used herein, the box volume may mean the smallest rectangular box that will fit the circular saw 100, as expressed in cubic units (e.g., cm³). Such a box 169 may have a width dimension (W), a length dimension (L) and a height dimension (H). In an example embodiment, the box 169 may have a width dimension of approximately 8.6 cm to approximately 9.6 cm and preferably approximately 9.1 cm, a length dimension of approximately 46 cm to approximately 47 cm and preferably approximately 46.5 cm and a height dimension of approximately 15.4 cm to approximately 16.4 cm and preferably approximately 15.9 cm. In an example embodiment, the circular saw 100 may have a box volume of approximately 6,092.24 cm³ to approximately 7,399.68 cm³. In an example embodiment, the circular saw 100 may have a box volume of approximately 6728.08 cm³ or less.

Referring to FIGS. 31 and 33A-35B, there is shown a third manner of expressing (or defining) a volume of the circular saw 100 (e.g., a shipping volume). In general, the circular saw may be placed in a shipping container 170 for shipping. The shipping container 170 includes a housing having a volume defined by interior surfaces of the container 170.

FIGS. 33B, 34B, 35B depict a right side elevation view, a top side plan view, and a rear side elevation view, respectively, of an example of an interior of the shipping container 170 having a predominantly rectangular shape. The shipping container 170 defines an interior volume defined by interior surfaces 170A, 170B, 170C, 170D, 170E, and 170F. The interior volume is generally a rectangular box. In an example, the container 170 may have an interior volume of approximately 6500 cm³ to approximately 7000 cm³. In an example embodiment, the container 170 may have an interior volume of approximately 6750 cm³ or less.

The circular saw 100, in the shipping configuration, may be placed into a tool storage void or cavity 172—the “shipping volume”—defined by the container 170 and packaging material, such as foam inserts, 174. As used herein, the shipping volume means the amount of 3D space taken up by the circular saw in a shipping container, as expressed in cubic units (e.g., cm³). The cavity 172 is defined by a combination of the interior surfaces 170A, 170B, 170C, 170D, 170E, 170F and the packaging material 174 where the circular saw 100 may be stored. The cavity 172 may be designed to fit tightly around a silhouette volume of the circular saw 100, or a volume surrounding a circumference of an exterior of the circular saw 100. In portions, a silhouette volume may encompass a volume beyond the circumference of the circular saw 100 to round out sharp corners or angles around the exterior where it would not be possible or reasonable to cut foam to fit within. In an example embodiment, the circular saw 100 may have a shipping volume of approximately 4100 cm³ to approximately 4400 cm³. In an example embodiment, the circular saw 100 may have a shipping volume of approximately 4257 cm³ or less.

In an example embodiment, the shipping container 170 and the circular saw 100 may have a fill ratio (shipping volume/interior volume) of approximately 62.5% to approximately 63.5%. In an example embodiment, the shipping container 170 and the circular saw 100 may have a fill ratio of at least approximately 63%.

The volume defined by the interior surfaces of the container may be equivalent to the box 169 defined above, with reference to FIG. 32.

By providing a smaller, streamlined shape, the circular saw 100 may be packaged in a very efficient way within a rectangle. This may provide for case of shipping and transporting the circular saw 100.

In an example embodiment, the circular saw 100 may have a power output (maximum watts out) of at least approximately 2000 W. In an example embodiment, the circular saw 100 may have a power output of at least approximately 2200 W. The circular saw 100 may operate with a blade size of approximately 17.8 cm to approximately 20.3 cm. The circular saw 100 may have a weight of approximately 2.42 kg or less to approximately 3.2 kg or less.

In an example embodiment, the circular saw 100 may have a power density (max Watts out/displacement volume) of at least approximately 1 W/cm³. In an example embodiment, the circular saw 100 may have a power density in a range from at least approximately 1.678 W/cm³ to at least approximately 1.717 W/cm³. In an example embodiment, the power density of the circular saw 100 may be at least approximately 1.697 W/cm³. In an example, the circular saw 100 may have a rotation speed of at least 6000, 6500, or 6850 RPM. In an example, the circular saw 100 may be configured to operate a blade size of at least 17.8 cm may have a power to weight ratio of at least approximately 650 W/kg, In an example embodiment, the circular saw 100 may have a power to weight ratio of at least approximately 929.75 W/kg.

The features of the circular saw 100 described herein may provide a light weight, more compact and powerful saw with improved power to weight, power density, depth of cut, and cut speed. The circular saw 100 may provide a unique ergonomic configuration that can be used ambidextrously, can be used to bevel in both directions, with a lightweight feel, a configurable handle and a more intuitive center of mass. The circular saw 100 may allow an operator to make more challenging cuts with easier set up. Finally, because the circular saw 100 may be so much more compact, it may be easier to package and transport.

A number of embodiments have been described. Nevertheless, it will be understood that various modifications may be made without departing from the spirit and scope of the specification.

In addition, any logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In some aspects, the techniques described herein relate to a circular saw including: a first motor including a first motor output shaft coupled to a first pinion; a second motor including a second motor output shaft coupled to a second pinion; and a transmission including: a master gear configured to engage the first pinion and the second pinion, an input pulley coupled to the master gear, the input pulley having a first diameter, and an output pulley coupled to an output shaft configured to rotate a saw blade, the output pulley having a second diameter that is smaller than the first diameter.

In some aspects, the techniques described herein relate to a circular saw, wherein the transmission further includes: a belt positioned around the input pulley and the output pulley.

In some aspects, the techniques described herein relate to a circular saw, wherein the belt is a toothed timing belt.

In some aspects, the techniques described herein relate to a circular saw, further including: a handle assembly; an upper saw blade housing; and a housing coupled to the handle assembly enclosing the transmission, the first motor, and the second motor, and wherein the first motor and the second motor are positioned between the handle assembly and the upper saw blade housing.

In some aspects, the techniques described herein relate to a circular saw, further including: a stationary shaft coupled to a housing enclosing the transmission, wherein the master gear and the input pulley are coupled to the stationary shaft via two bearing assemblies.

In some aspects, the techniques described herein relate to a circular saw, wherein the first pinion, the second pinion and the master gear are straight cut gears.

In some aspects, the techniques described herein relate to a circular saw, wherein the transmission achieves at least a 4:1 gear reduction.

In some aspects, the techniques described herein relate to a circular saw, wherein the master gear and the input pulley are coupled together.

In some aspects, the techniques described herein relate to a circular saw, further including: a housing enclosing the transmission, the first motor, and the second motor, the housing having a width along a rotational axis of a saw blade that is 9.5 cm or less.

In some aspects, the techniques described herein relate to a circular saw, further including: a rotational saw flange having a diameter that is 3.2 cm or less.

In some aspects, the techniques described herein relate to a circular saw, wherein the output pulley has an output pulley rotation speed that is greater than a master gear rotation speed of the master gear.

In some aspects, the techniques described herein relate to a circular saw, wherein the circular saw has a power density greater than or equal to 1 W/cm³.

In some aspects, the techniques described herein relate to a circular saw, wherein the circular saw has a power to weight ratio of 700 W/kg or more.

In some aspects, the techniques described herein relate to a circular saw, wherein the circular saw is configured to rotate a saw blade with a blade diameter of 18.415 cm and operable to generate a depth of cut of at least 6.6675 cm.

In some aspects, the techniques described herein relate to a circular saw, including: a housing; an upper blade housing coupled to the housing and rotatably coupled to an output shaft; the output shaft operable to rotate a saw blade coupled to the output shaft via a flange in a saw blade plane, the flange having a flange diameter; a motor at least partially enclosed within the housing and overlapping the saw blade plane; and an output rotatable drive element coupled to the output shaft and operable to be rotated by the motor, the output rotatable drive element having an output drive element diameter that is less than or equal to the flange diameter.

In some aspects, the techniques described herein relate to a circular saw, further including: a shoe coupled to the upper blade housing; a pivot block coupled to the shoe, the pivot block including an arch segment; and a pivot roller coupled to the upper blade housing and positioned in a center portion of the arch segment when a surface of the shoe is perpendicular to the saw blade plane.

In some aspects, the techniques described herein relate to a circular saw, wherein the shoe is operable to tilt over at least a range from −45 to 45 degrees of the saw blade plane.

In some aspects, the techniques described herein relate to a circular saw, wherein the shoe is operable to tilt over at least a range from −52 and 52 degrees of the saw blade plane.

In some aspects, the techniques described herein relate to a circular saw, wherein the motor is a first motor that rotates a first pinion and the circular saw further includes: a second motor that rotates a second pinion; and a master gear configured to engage the first pinion and the second pinion.

In some aspects, the techniques described herein relate to a circular saw, wherein the circular saw further includes: a motor rotatable drive element coupled to the motor and configured to transfer torque to the output rotatable drive element, the output rotatable drive element having an output drive element rotation speed that is less than a motor rotatable speed of a second rotatable drive element.

In some aspects, the techniques described herein relate to a circular saw, wherein the output drive element rotation speed is at least 6500 RPM.

In some aspects, the techniques described herein relate to a circular saw, wherein the motor rotatable drive element is an output pulley and the output rotatable drive element is an input pulley, and the circular saw further includes: a belt drive that transfers torque between the motor rotatable drive element and the output rotatable drive element.

In some aspects, the techniques described herein relate to a circular saw, wherein the housing has a length in a direction of a rotational axis of the saw blade that is less than 9.5 cm.

In some aspects, the techniques described herein relate to a circular saw, wherein the output rotatable drive element has an output drive element diameter that is less than or equal to approximately 20% of a saw blade diameter of the saw blade.

In some aspects, the techniques described herein relate to a circular saw, wherein the output rotatable drive element has an output drive element diameter that is less than or equal to approximately 16.5% of a saw blade diameter of the saw blade.

In some aspects, the techniques described herein relate to a circular saw, including: a saw blade in a saw blade plane; a first handle assembly; a motor housing and a motor positioned inside the motor housing, the motor housing between the saw blade and the first handle assembly; and a circular saw center of mass in the saw blade plane and between the first handle assembly and the motor housing.

In some aspects, the techniques described herein relate to a circular saw, further including: a transmission positioned on a side of the motor housing, wherein the motor and the transmission have a combined motor-transmission center of mass that is in the saw blade plane.

In some aspects, the techniques described herein relate to a circular saw, further including: a battery receptacle coupled to the motor housing, the battery receptacle centered on the saw blade plane.

In some aspects, the techniques described herein relate to a circular saw, further including: a battery pack coupled to the motor housing with a battery pack center of mass centered on the saw blade plane.

In some aspects, the techniques described herein relate to a circular saw, further including a upper blade housing assembly configured to house an upper portion of the saw blade and a second handle assembly coupled to the upper blade housing assembly in the saw blade plane.

In some aspects, the techniques described herein relate to a circular saw, further including: a shoe, the shoe having center of mass in the saw blade plane.

In some aspects, the techniques described herein relate to a circular saw, wherein at least one of a center of mass of the first handle assembly and a center of mass of the motor housing is in the saw blade plane.

In some aspects, the techniques described herein relate to a circular saw, including: an upper blade housing assembly coupled to an input shaft configured to rotate a saw blade in a saw blade plane; and a handle coupled to a circumference of the upper blade housing assembly via a fastener.

In some aspects, the techniques described herein relate to a circular saw, wherein the handle is pivotable to a first side or a second side of the saw blade plane.

In some aspects, the techniques described herein relate to a circular saw, wherein the fastener includes a camming lever.

In some aspects, the techniques described herein relate to a circular saw, wherein the handle conforms to a semicircular shape of the circumference of the upper blade housing assembly.

In some aspects, the techniques described herein relate to a circular saw, wherein the upper blade housing assembly further includes a track along the circumference operable to seat and translate the fastener that couples the handle to the circumference.

In some aspects, the techniques described herein relate to a circular saw, wherein the track has a t-shaped cross-sectional area.

In some aspects, the techniques described herein relate to a circular saw, including: a housing configured to enclose a motor overlapping with a saw blade plane; an upper blade housing coupled to the housing and operable to enclose a portion of a saw blade; a first handle coupled to the housing at an end opposite the upper blade housing; and a second handle coupled to and translatable along a circumference of the upper blade housing.

In some aspects, the techniques described herein relate to a circular saw, further including: the motor enclosed within the housing and overlapping the saw blade plane of the saw blade.

In some aspects, the techniques described herein relate to a circular saw, further including: an exterior packaging for storing the circular saw that is rectangular in shape.

In some aspects, the techniques described herein relate to a circular saw, wherein the circular saw has volume that is 80% or greater of an exterior package volume.

In some aspects, the techniques described herein relate to a circular saw, wherein the exterior packaging has a volume that is 1500 cm³ or less.

In some aspects, the techniques described herein relate to a circular saw, including: a circular saw body configured to rotate a saw blade in a saw blade plane; and a shoe coupled to the circular saw body bifurcated by the saw blade plane into a first portion and a second portion, wherein a first force applied between the first portion to a workpiece substantially equals a second force applied between the second portion the workpiece.

In some aspects, the techniques described herein relate to a circular saw, wherein the first portion of the shoe has a first surface area and the second portion of the shoe has a second surface area, and a difference between the first surface area and the second surface area is less than 0.1 cm².

In some aspects, the techniques described herein relate to a circular saw, wherein a frictional pivot point of the circular saw is in the saw blade plane.

In some aspects, the techniques described herein relate to a circular saw, wherein the first force and the second force are generally parallel to the saw blade plane.

In some aspects, the techniques described herein relate to a circular saw, wherein the saw blade has a rotational axis and the first force and the second force are generally perpendicular to a saw blade rotational axis.

In some aspects, the techniques described herein relate to a circular saw including: a saw blade; a motor; a transmission configured to transfer torque from the motor to an output shaft coupled to the saw blade, the output shaft having a rotational axis; a housing enclosing the motor and the transmission, the housing having a housing dimension along the rotational axis; and a shoe, the shoe having a shoe dimension along the rotational axis, the housing dimension being less than or equal to the shoe dimension.

In some aspects, the techniques described herein relate to a circular saw, wherein the saw blade is positioned in a saw blade plane, the saw blade plane generally perpendicular to the rotational axis and the housing dimension and the shoe dimension are centered on the saw blade plane.

In some aspects, the techniques described herein relate to a power tool including: a housing including a top portion and a bottom portion; a motor positioned inside the housing; a handle assembly including a top handle end coupled to the top portion of the housing and a second handle end coupled to the bottom portion of the housing; an inlet vent positioned on a first of the housing or the handle assembly; and an exhaust vent positioned on a second of the housing or the handle assembly, wherein an air path between the inlet vent and the exhaust vent traverses a length of the handle assembly from a first handle end to a second handle end.

In some aspects, the techniques described herein relate to a power tool, wherein the air path passes through the motor.

In some aspects, the techniques described herein relate to a power tool, wherein the air path passes through an electronics in the handle assembly.

In some aspects, the techniques described herein relate to a power tool, wherein the motor includes a fan to push air through at least a portion of the air path.

In some aspects, the techniques described herein relate to a power tool, wherein the inlet vent is adjacent to a trigger in the handle assembly or the top handle end of the handle assembly.

In some aspects, the techniques described herein relate to a power tool, wherein the exhaust vent is adjacent to the motor in the housing.

What is claimed is:

1. A circular saw comprising:
a first motor including a first motor output shaft coupled to a first pinion;
a second motor including a second motor output shaft coupled to a second pinion; and
a transmission including:
a master gear configured to engage the first pinion and the second pinion,
an input pulley coupled to the master gear, the input pulley having a first diameter, and
an output pulley coupled to an output shaft configured to rotate a saw blade, the output pulley having a second diameter that is smaller than the first diameter.

2. The circular saw of claim 1, wherein the transmission further includes:
a belt positioned around the input pulley and the output pulley.

3. The circular saw of claim 2, wherein the belt is a toothed timing belt.

4. The circular saw of claim 1, further comprising:
a handle assembly;
an upper saw blade housing; and
a housing coupled to the handle assembly enclosing the transmission, the first motor, and the second motor, and wherein the first motor and the second motor are positioned between the handle assembly and the upper saw blade housing.

5. The circular saw of claim 1, further comprising:
a stationary shaft coupled to a housing enclosing the transmission, wherein the master gear and the input pulley are coupled to the stationary shaft via two bearing assemblies.

6. The circular saw of claim 1, wherein the first pinion, the second pinion and the master gear are straight cut gears.

7. The circular saw of claim 1, wherein the transmission achieves at least a 4:1 gear reduction.

8. The circular saw of claim 1, wherein the master gear and the input pulley are coupled together.

9. The circular saw of claim 1, further comprising:
a housing enclosing the transmission, the first motor, and the second motor, the housing having a width along a rotational axis of a saw blade that is 9.5 cm or less.

10. The circular saw of claim 1, further comprising:
a rotational saw flange having a diameter that is 3.2 cm or less.

11. The circular saw of claim 1, wherein the output pulley has an output pulley rotation speed that is greater than a master gear rotation speed of the master gear.

12. The circular saw of claim 1, wherein the circular saw has a power density greater than or equal to 1 W/cm³.

13. The circular saw of claim 1, wherein the circular saw has a power to weight ratio of 700 W/kg or more.

14. The circular saw of claim 1, wherein the circular saw is configured to rotate a saw blade with a blade diameter of 18.415 cm and operable to generate a depth of cut of at least 6.6675 cm.

15. A circular saw, comprising:
a housing;
an upper blade housing coupled to the housing and rotatably coupled to an output shaft;
the output shaft operable to rotate a saw blade coupled to the output shaft via a flange in a saw blade plane, the flange having a flange diameter;
a motor at least partially enclosed within the housing and overlapping the saw blade plane; and
an output rotatable drive element coupled to the output shaft and operable to be rotated by the motor, the output rotatable drive element having an output drive element diameter that is less than or equal to the flange diameter.

16. The circular saw of claim 15, further comprising:
a shoe coupled to the upper blade housing;
a pivot block coupled to the shoe, the pivot block including an arch segment; and
a pivot roller coupled to the upper blade housing and positioned in a center portion of the arch segment when a surface of the shoe is perpendicular to the saw blade plane.

17. The circular saw of claim 16, wherein the shoe is operable to tilt over at least a range from −45 to 45 degrees of the saw blade plane.

18. The circular saw of claim 16, wherein the shoe is operable to tilt over at least a range from −52 and 52 degrees of the saw blade plane.

19. The circular saw of claim 15, wherein the motor is a first motor that rotates a first pinion and the circular saw further includes:
a second motor that rotates a second pinion; and
a master gear configured to engage the first pinion and the second pinion.

20. The circular saw of claim 15, wherein the circular saw further includes:
a motor rotatable drive element coupled to the motor and configured to transfer torque to the output rotatable drive element, the output rotatable drive element having an output drive element rotation speed that is less than a motor rotatable speed of a second rotatable drive element.

21. The circular saw of claim 20, wherein the output drive element rotation speed is at least 6500 RPM.

22. The circular saw of claim 20, wherein the motor rotatable drive element is an output pulley and the output rotatable drive element is an input pulley, and the circular saw further comprises:
a belt drive that transfers torque between the motor rotatable drive element and the output rotatable drive element.

23. The circular saw of claim 15, wherein the housing has a length in a direction of a rotational axis of the saw blade that is less than 9.5 cm.

24. The circular saw of claim 15, wherein the output rotatable drive element has an output drive element diameter that is less than or equal to approximately 20% of a saw blade diameter of the saw blade.

25. The circular saw of claim 15, wherein the output rotatable drive element has an output drive element diameter that is less than or equal to approximately 16.5% of a saw blade diameter of the saw blade.

26. A circular saw, comprising:
a saw blade in a saw blade plane;
a first handle assembly;
a motor housing and a motor positioned inside the motor housing, the motor housing between the saw blade and the first handle assembly; and
a circular saw center of mass in the saw blade plane and between the first handle assembly and the motor housing.

27. The circular saw of claim 26, further comprising:
a transmission positioned on a side of the motor housing, wherein the motor and the transmission have a combined motor-transmission center of mass that is in the saw blade plane.

28. The circular saw of claim 26, further comprising:
a battery receptacle coupled to the motor housing, the battery receptacle centered on the saw blade plane.

29. The circular saw of claim 26, further comprising:
a battery pack coupled to the motor housing with a battery pack center of mass centered on the saw blade plane.

30. The circular saw of claim 26, further comprising a upper blade housing assembly configured to house an upper portion of the saw blade and a second handle assembly coupled to the upper blade housing assembly in the saw blade plane.

31. The circular saw of claim 26, further comprising:
a shoe, the shoe having center of mass in the saw blade plane.

32. The circular saw of claim 26, wherein at least one of a center of mass of the first handle assembly and a center of mass of the motor housing is in the saw blade plane.
